(19) United States
(12) Patent Application Publication
(10) Pub. No.: US 2023/0037664 A1
(43) Pub. Date: Feb. 9, 2023

(54) REAR-MOVING SELF-PROPELLED WORKING MACHINE

(71) Applicant: Nanjing Chervon Industry Co., Ltd., Nanjing (CN)

(72) Inventors: Ronggen Zhu, Nanjing (CN); Yufei Ren, Nanjing (CN); Dezhong Yang, Nanjing (CN); Yang Li, Nanjing (CN); Haishen Xu, Nanjing (CN); Rui Zhang, Nanjing (CN)

(21) Appl. No.: 17/972,272

(22) Filed: Oct. 24, 2022

Related U.S. Application Data
(63) Continuation-in-part of application No. 17/576,567, filed on Jan. 14, 2022.
Application No. 17/576,567 is a continuation of application No. PCT/CN2020/104524, filed on Jul. 24, 2020.
Application No. PCT/CN2020/104524 is a continuation of application No. PCT/CN2022/083092, filed on Mar. 25, 2022.

(30) Foreign Application Priority Data
Jul. 25, 2019 (CN) 201910674384.8
Oct. 21, 2019 (CN) 201911001974.0
Apr. 27, 2021 (CN) 202110457354.9
Apr. 27, 2021 (CN) 202110462557.7
Apr. 27, 2021 (CN) 202120891569.7
Apr. 27, 2021 (CN) 202120893833.0
Apr. 27, 2021 (CN) 202120894570.5

(51) Int. Cl. A01D 34/69; A01D 34/78

(52) U.S. Cl. CPC A01D 34/69; A01D 34/78; A01D 2101/00

(57) ABSTRACT

A rear-moving, self-propelled working machine includes a main machine and a handle device. The main machine includes a moving assembly and a motor for driving the moving assembly. The handle device is connected to the main machine and includes an operation member, a connecting rod assembly, a housing, a sensing device, and a trigger assembly. The operation member includes a grip for a user to hold. The connecting rod assembly includes a first connecting rod connected to the main machine. The sensing device is used for sensing a thrust applied to the handle device to drive the rear-moving, self-propelled working machine. The trigger assembly is capable of applying a force to the sensing device when the grip receives the thrust. The trigger assembly is connected to the connecting rod assembly, and the sensing device is connected to the operation member.

### RELATED APPLICATION INFORMATION

This application is a continuation-in-part of U.S. application Ser. No. 17/576,567, filed on Jan. 14, 2022, which application is a continuation of International Application Number PCT/CN2020/104524, filed on Jul. 24, 2020, through which this application also claims the benefit under 35 U.S.C. § 119(a) of Chinese Patent Application No. CN 201910674384.8, filed on Jul. 25, 2019, and Chinese Patent Application No. CN 201911001974.0, filed on Oct. 21, 2019.

This application is also a continuation of International Application Number PCT/CN2022/083092, filed on Mar. 25, 2022, through which this application also claims the benefit under 35 U.S.C. § 119(a) of Chinese Patent Application No. CN 202110457354.9, filed on Apr. 27, 2021, Chinese Patent Application No. CN 202120893833.0, filed on Apr. 27, 2021, Chinese Patent Application No. CN 202120891569.7, filed on Apr. 27, 2021, Chinese Patent Application No. CN 202120894570.5, filed on Apr. 27, 2021, and Chinese Patent Application No. CN 202110462557.7, filed on Apr. 27, 2021.

Each of these publications is incorporated herein by reference in its entirety.

### BACKGROUND

A lawn mower is a rear-moving, self-propelled working machine, and a user may stand behind the lawn mower to push the lawn mower to walk, so as to mow home lawns. When the user pushes the lawn mower on the grass for a long time to mow a lawn, a lot of physical effort is consumed. To reduce a labor intensity of an operator mowing the grass, a self-moving lawn mower appears on the market.

### SUMMARY

A rear-moving, self-propelled working machine includes a main machine and a handle device. The main machine includes a moving assembly and a motor for driving the moving assembly. The handle device is connected to the main machine. The handle device includes an operation member, a connecting rod assembly, a housing, a sensing device, and a trigger assembly. The operation member includes a grip for a user to hold. The connecting rod assembly includes a first connecting rod connected to the main machine. The housing is formed with a first accommodation cavity, where the first connecting rod extends into the first accommodation cavity. The sensing device is used for sensing a thrust applied to the handle device to drive the rear-moving, self-propelled working machine. The trigger assembly is capable of applying a force to the sensing device when the grip receives the thrust so as to drive the sensing device to deform. The trigger assembly is connected to the connecting rod assembly, and the sensing device is connected to the operation member.

In an example, the sensing device includes a pressure sensor, and when the grip receives the thrust, the trigger assembly applies the force to the pressure sensor to drive the pressure sensor to deform.

In an example, the operation member is formed with a second accommodation cavity, where the pressure sensor is at least partially disposed in the second accommodation cavity.

In an example, the operation member is disposed outside the housing.

In an example, the pressure sensor is disposed outside the housing.

In an example, the trigger assembly includes a trigger piece and a slider. The trigger piece is used for applying the force to the pressure sensor. The slider is connected to the first connecting rod. The handle device further includes a support piece for supporting the slider, the slider is in contact with the trigger piece, the support piece is fixedly connected to the operation member, and the slider penetrates through the support piece.

In an example, when the operation member receives the thrust, a relative motion between the support piece and the slider is capable of being generated to deform the pressure sensor, where a maximum value of the relative motion between the support piece and the slider is less than or equal to 3 mm.

In an example, the support piece is disposed in the housing.

In an example, the trigger piece includes a sphere portion in contact with the pressure sensor.

In an example, the trigger piece is a sphere.

In an example, the sensing device includes a pressure sensor and the handle device further includes a preload element for biasing the trigger assembly to apply a preload force to the pressure sensor.

In an example, the connecting rod assembly further includes a second connecting rod connected to the main machine, and the housing is connected to the first connecting rod and the second connecting rod.

A rear-moving, self-propelled working machine includes a main machine and a handle device. The main machine includes a moving assembly and a motor for driving the moving assembly. The handle device is connected to the main machine. The handle device includes an operation member, a connecting rod assembly, a housing, a sensing device, and a trigger assembly. The operation member includes a grip for a user to operate. The connecting rod assembly includes a connecting rod connected to the main machine. The housing is formed with a first accommodation cavity, where the connecting rod extends into the first accommodation cavity. The sensing device is used for sensing a thrust applied to the handle device to drive the rear-moving, self-propelled working machine. The trigger assembly is capable of applying a force to the sensing device when the grip receives the thrust so as to drive the sensing device to deform. The sensing device is disposed outside the housing.

A rear-moving, self-propelled working machine includes a main machine and a handle device. The main machine includes a moving assembly and a motor for driving the moving assembly. The handle device is connected to the main machine. The handle device includes an operation member, a connecting rod assembly, a housing, a sensing device, and a trigger assembly. The operation member includes a grip for a user to operate. The connecting rod assembly includes a connecting rod connected to the main machine. The housing is formed with a first accommodation cavity, where the connecting rod extends into the first accommodation cavity. The sensing device is used for sensing a thrust applied to the handle device to drive the rear-moving, self-propelled working machine. The trigger assembly is capable of applying a force to the sensing device when the grip receives the thrust. The sensing device is disposed outside the housing.

A rear-moving, self-propelled working machine includes a main machine and a handle device. The main machine includes a moving assembly and a motor for driving the moving assembly. The handle device is connected to the main machine. The handle device includes an operation member, a connecting rod assembly, a sensing device, and a trigger assembly. The operation member includes a grip for a user to operate and a mounting portion disposed at an end of the grip. The connecting rod assembly includes a connecting rod connecting the mounting portion to the main machine. The sensing device is used for sensing a thrust applied to the handle device to drive the rear-moving, self-propelled working machine. The trigger assembly is capable of applying a force to the sensing device when the grip receives the thrust so as to drive the sensing device to deform. The mounting portion is formed with an accommodation cavity, where the sensing device is disposed in the accommodation cavity. One of the sensing device or the trigger assembly is mounted to the mounting portion, and the other one of the sensing device or the trigger assembly is mounted to the connecting rod assembly.

In some examples, the operation member is disposed outside a housing, and the support piece is at least partially disposed in the housing.

A rear-moving, self-propelled working machine includes a main machine and a handle device. The main machine includes a moving assembly and a motor for driving the moving assembly. The handle device is connected to the main machine. The handle device includes an operation member, a connecting rod assembly, and a pressure sensor. The operation member includes a grip for a user to hold. The connecting rod assembly includes a first connecting rod connected to the main machine. The pressure sensor is used for sensing a thrust applied to the handle device to drive the rear-moving, self-propelled working machine. The rear-moving, self-propelled working machine further includes a trigger piece for applying a force to the pressure sensor and a support piece made of a first material, where the trigger piece is formed with or connected to a slider, the support piece supports the slider, and the slider is made of a second material different from the first material; and when the operation member receives the thrust, a relative motion between the support piece and the slider is generated to deform the pressure sensor.

In some examples, a maximum value of the relative motion between the support piece and the slider is less than or equal to 2 mm.

In some examples, a coefficient of friction between the support piece and the slider is greater than 0 and less than or equal to 0.3.

In some examples, a coefficient of friction between the support piece and the slider is greater than 0 and less than or equal to 0.1.

In some examples, the support piece is a metal piece and the slider is a plastic piece.

In some examples, the first material is a first metal and the second material is a second metal.

In some examples, the support piece is formed with a support hole centered on a first straight line, and the slider is at least partially disposed in the support hole; where the support hole includes a first hole wall portion with a first inner diameter and a second hole wall portion with a second inner diameter, where the slider is in contact with the first hole wall portion and also in contact with the second hole wall portion, and the first inner diameter is greater than the second inner diameter.

In some examples, the first hole wall portion and the second hole wall portion are disposed at different positions on the first straight line.

In some examples, the support piece is connected to the operation member, and the slider is connected to the connecting rod assembly.

In some examples, the handle device further includes a housing, where the housing is formed with a first accommodation cavity, the first connecting rod extends into the first accommodation cavity, and the pressure sensor is disposed outside the housing.

In some examples, the operation member is formed with a second accommodation cavity, where the pressure sensor is disposed in the second accommodation cavity.

In some examples, the operation member is disposed outside the housing, and the support piece is at least partially disposed in the housing.

A rear-moving, self-propelled working machine includes a main machine and a handle device. The main machine includes a moving assembly and a motor assembly for driving the moving assembly. The handle device is connected to the main machine. The handle device includes an operation member, a connecting rod assembly, a pressure sensor, and a trigger piece. The operation member includes a grip for a user to hold. The connecting rod assembly includes a first connecting rod connected to the main machine. The pressure sensor is used for sensing a thrust applied to the handle device to drive the rear-moving, self-propelled working machine. The trigger piece is capable of applying a force to the pressure sensor when the grip receives the thrust so as to drive the pressure sensor to deform. The trigger piece includes a triggering surface for being in contact with the pressure sensor, where the triggering surface is at least part of a spherical surface.

In some examples, the trigger piece is a sphere.

In some examples, the pressure sensor is formed with a hole for being in contact with the trigger piece.

In some examples, the first connecting rod extends along a first straight line, and an area of a projection of the triggering surface on a plane perpendicular to the first straight line is greater than an area of a projection of the hole in a direction of the first straight line.

In some examples, the triggering surface is at least partially embedded into the hole.

In some examples, the pressure sensor is connected to the operation member, and the trigger piece is disposed between the pressure sensor and the connecting rod assembly.

In some examples, the first connecting rod extends along a first straight line, and a position of the trigger piece relative to the connecting rod assembly in a direction of the first straight line remains fixed.

In some examples, the pressure sensor is connected to the connecting rod assembly, and the trigger piece is disposed between the pressure sensor and the operation member.

In some examples, the first connecting rod extends along a first straight line, and a position of the pressure sensor relative to the connecting rod assembly in a direction of the first straight line remains fixed.

In some examples, the handle device further includes a preload element for biasing the trigger piece such that the trigger piece is always in contact with the pressure sensor.

A rear-moving, self-propelled working machine includes a main machine and a handle device. The main machine includes a moving assembly and a motor assembly for driving the moving assembly. The handle device is connected to the main machine. The handle device includes an operation member, a connecting rod assembly, a pressure sensor, and a trigger piece. The operation member includes a grip for a user to hold. The connecting rod assembly includes a first connecting rod connected to the main machine. The pressure sensor is used for sensing a thrust applied to the handle device to drive the rear-moving, self-propelled working machine. The trigger piece is capable of applying a force to the pressure sensor when the grip receives the thrust so as to drive the pressure sensor to deform. The trigger piece includes a trigger portion for being in contact with the pressure sensor, where the trigger portion is a sphere portion.

A rear-moving, self-propelled working machine includes a main machine and a handle device. The main machine includes a moving assembly and a motor assembly for driving the moving assembly. The handle device is connected to the main machine. The handle device includes an operation member, a connecting rod assembly, a pressure sensor, and a trigger piece. The operation member includes a grip for a user to hold. The connecting rod assembly includes a first connecting rod connected to the main machine. The pressure sensor is used for sensing a thrust applied to the handle device to drive the rear-moving, self-propelled working machine. The trigger piece is capable of applying a force to the pressure sensor when the grip receives the thrust so as to drive the pressure sensor to deform. The trigger piece includes a triggering surface for being in contact with the pressure sensor, and the pressure sensor includes a triggered surface for being in contact with the triggering surface, where the triggered surface is at least part of a spherical surface.

A rear-moving, self-propelled working machine includes a main machine and a handle device. The main machine includes a moving assembly and a motor assembly for driving the moving assembly. The handle device is connected to the main machine. The handle device includes an operation member, a connecting rod assembly, a sensing device, and a trigger piece. The operation member includes a grip for a user to hold. The connecting rod assembly includes a first connecting rod connected to the main machine. The sensing device is used for sensing a thrust applied to the handle device to drive the rear-moving, self-propelled working machine. The trigger piece is capable of applying a force to the sensing device when the grip receives the thrust. The grip includes a first end and a second end. The operation member further includes a first mounting portion and a second mounting portion. The first mounting portion includes a first mounting end for mounting the sensing device or the trigger piece, where the first mounting portion is disposed at the first end of the grip. The second mounting portion includes a second mounting end for mounting the sensing device or the trigger piece, where the second mounting portion is disposed at the second end of the grip. The handle device further includes a connecting piece for fixedly connecting the first mounting end and the second mounting end.

In some examples, the first mounting end is away from the first end and the second mounting end is away from the second end.

In some examples, the connecting piece is formed with a first accommodation cavity into which the connecting rod assembly is inserted.

In some examples, the connecting rod assembly further includes a second connecting rod connected to the main machine, and the connecting piece is at least partially disposed between the first connecting rod and the second connecting rod.

In some examples, the connecting piece includes a first housing portion and a second housing portion that are dockable, where the first housing portion docks with the second housing portion so as to form a first accommodation cavity into which the connecting rod assembly or the operation member is inserted.

In some examples, the sensing device includes a pressure sensor disposed outside the first accommodation cavity.

In some examples, the handle device further includes a support piece for supporting the operation member, where the support piece is fixedly connected to the operation member, the support piece is at least partially disposed in the first accommodation cavity, and the support piece is fixedly connected to the connecting piece.

A rear-moving, self-propelled working machine includes a main machine and a handle device. The main machine includes a moving assembly and a motor assembly for driving the moving assembly. The handle device is connected to the main machine. The handle device includes an operation member, a connecting rod assembly, a sensing device, and a trigger piece. The operation member includes a grip for a user to hold. The connecting rod assembly includes a first connecting rod connected to the main machine. The sensing device is used for sensing a thrust applied to the handle device to drive the rear-moving, self-propelled working machine. The trigger piece is capable of applying a force to the sensing device when the grip receives the thrust. The grip includes a first end and a second end. The operation member further includes a first mounting portion and a second mounting portion. The first mounting portion is used for mounting the sensing device or the trigger piece and disposed at the first end of the grip. The second mounting portion is used for mounting the sensing device or the trigger piece and disposed at the second end of the grip. The handle device further includes a connecting piece for fixedly connecting the first mounting portion and the second mounting portion.

In some examples, the first connecting rod extends along a direction of a first straight line; and a distance between the connecting piece and the grip along the direction of the first straight line is greater than or equal to 40 mm and less than or equal to 200 mm.

In some examples, the first connecting rod extends along a direction of a first straight line; and a ratio of a distance between the connecting piece and the grip along the direction of the first straight line to a dimension of the operation member along the direction of the first straight line is greater than or equal to 0.5 and less than 1.

A rear-moving, self-propelled working machine includes a main machine, an operation switch, and a handle device. The main machine includes a moving assembly and a drive motor for driving the moving assembly. The operation switch is connected to the drive motor. The handle device is connected to the main machine. The handle device includes an operation member and a connecting rod. The operation member includes a grip for a user to hold. The connecting rod is connected to the main machine. The rear-moving, self-propelled working machine further includes a pressure sensor and a signal transmission device. The pressure sensor is disposed on the handle device and capable of outputting a first signal according to a sensed thrust applied to the handle device to drive the rear-moving, self-propelled working machine. The signal transmission device is used for identifying the first signal and transmitting the first signal to a control unit. The control unit is configured to acquire a second signal fed back by the drive motor; and acquire the first signal outputted by the signal transmission device and control output torque of the drive motor according to the first signal and the second signal fed back by the drive motor such that the drive motor outputs a desired driving force.

In some examples, the first signal includes an optical signal or an electrical signal.

In some examples, the signal transmission device transmits an electrical signal to the control unit based on bus communication.

In some examples, the control unit is configured to not acquire a motor rotational speed fed back by the drive motor.

In some examples, the control unit is configured to not acquire a motor rotational speed fed back by the drive motor.

In some examples, the output torque is positively correlated to the thrust.

In some examples, the pressure sensor is disposed on the grip of the operation member.

In some examples, the signal transmission device is disposed at a position adjacent to a periphery of the pressure sensor.

In some examples, the signal transmission device and the pressure sensor are disposed in a handle housing on the handle device together.

In some examples, the pressure sensor includes a first pressure sensor and a second pressure sensor.

In some examples, the rear-moving, self-propelled working machine further includes a first signal processing device for receiving the electrical signal outputted by the pressure sensor and performing operational amplification on the electrical signal to obtain a first processed signal. The signal transmission device identifies the first processed signal and transmits the first processed signal to the control unit through bus communication. The control unit is configured to acquire the first processed signal and control the output torque of the drive motor according to the first processed signal and the second signal such that the drive motor outputs the desired driving force.

In some examples, the rear-moving, self-propelled working machine further includes a second signal processing device for receiving the electrical signal outputted by the pressure sensor and performing analog-to-digital conversion (ADC) on the electrical signal to obtain a second processed signal. The signal transmission device identifies the second processed signal and transmits the second processed signal to the control unit through bus communication. The control unit is configured to acquire the second processed signal and control the output torque of the drive motor according to the second processed signal and the second signal fed back by the drive motor such that the drive motor outputs the desired driving force.

In some examples, the control unit is configured to calculate a variation of the thrust at a certain frequency; and when the variation of the thrust is greater than or equal to a variation threshold, control the output torque of the drive motor according to the first signal outputted by the pressure sensor and the second signal fed back by the drive motor such that the drive motor outputs the desired driving force.

A rear-moving, self-propelled working machine for adaptively adjusting a driving force includes a main machine, an operation switch, and a handle device. The main machine includes a moving assembly and a drive motor for driving the moving assembly. The operation switch is connected to the drive motor. The handle device is connected to the main machine. The handle device includes an operation member and a connecting rod. The operation member includes a grip for a user to hold. The connecting rod is connected to the main machine. The rear-moving, self-propelled working machine further includes a pressure sensor and a signal transmission device. The pressure sensor is disposed on the handle device and capable of outputting a first signal according to a sensed thrust applied to the handle device to drive the rear-moving, self-propelled working machine. The signal transmission device is used for identifying the first signal and transmitting the first signal to a control unit. The control unit is configured to acquire a second signal fed back by the drive motor; acquire the first signal outputted by the signal transmission device and control output torque of the drive motor according to the first signal, the second signal fed back by the drive motor and a current signal fed back by the drive motor such that the drive motor outputs a desired driving force; and not acquire a motor rotational speed fed back by the drive motor and thus not control the rotational speed of the drive motor according to the output torque.

### BRIEF DESCRIPTION OF DRAWINGS

FIG. 1 is a perspective view of a walk-behind, self-propelled working machine;

FIG. 2 is a perspective view of a handle device of the walk-behind, self-propelled working machine in FIG. 1;

FIG. 3 is a sectional view of part of a structure of a handle device of the walk-behind, self-propelled working machine in FIG. 1;

FIG. 4 is an exploded view of part of a structure of a handle device of the walk-behind, self-propelled working machine in FIG. 1;

FIG. 5 is an exploded view of part of the structure of the handle device of the walk-behind, self-propelled working machine in FIG. 4 from another angle;

FIG. 6 is a logic control diagram illustrating that a sensing device of the walk-behind, self-propelled working machine in FIG. 1 receives signals;

FIG. 7 is a trend chart illustrating relationships between a speed of and a thrust on the walk-behind, self-propelled working machine in FIG. 1 and time;

FIG. 8 is a logic control diagram illustrating that a sensing device of the walk-behind, self-propelled working machine in FIG. 1 receives a signal;

FIG. 9 is a logic control diagram of an array acquisition process of a left pressure sensor of the walk-behind, self-propelled working machine in FIG. 1;

FIG. 10 is a logic control diagram of an array acquisition process of a right pressure sensor of the walk-behind, self-propelled working machine in FIG. 1;

FIG. 11 is a logic control diagram of a response of a motor after a thrust value is acquired for the walk-behind, self-propelled working machine in FIG. 1;

FIG. 12 is a logic control diagram for determining whether a motor is activated for the walk-behind, self-propelled working machine in FIG. 1;

FIG. 13 is a logic control diagram for determining a response manner of a thrust for the walk-behind, self-propelled working machine in FIG. 1; and

FIG. 14 is a logic control diagram of PID adjustment for the walk-behind, self-propelled working machine in FIG. 1.

FIG. 15 is a perspective view of a rear-moving, self-propelled working machine;

FIG. 16 is a perspective view of part of a handle device of the rear-moving, self-propelled working machine in FIG. 15;

FIG. 17 is a plan view of the structure shown in FIG. 16;

FIG. 18 is a sectional view of the structure shown in FIG. 16;

FIG. 19 is an enlarged view of a partial region in FIG. 18;

FIG. 20 is an enlarged view of a support piece, a slider, and a preload element in FIG. 19;

FIG. 21 is a plan view of part of the handle device in FIG. 17 with an operation member separated;

FIG. 22 is an enlarged view of a partial region in FIG. 21;

FIG. 23 is a plan view of the structure shown in FIG. 21 with part of a housing removed;

FIG. 24 is an enlarged view of a partial region in FIG. 23;

FIG. 25 is an exploded view of part of the handle device in FIG. 16;

FIG. 26 is a sectional view of a pressure sensor and a trigger piece in FIG. 18 when the pressure sensor is basically not deformed;

FIG. 27 is a sectional view of a pressure sensor and a trigger piece in FIG. 18 when the pressure sensor is deformed;

FIG. 28A is a plan view of a trigger piece according to another example;

FIG. 28B is a plan view of a pressure sensor and a trigger piece according to another example;

FIG. 28C is a plan view of a pressure sensor and a trigger piece according to another example;

FIG. 29 is a perspective view of a handle device of a lawn mower according to another example;

FIG. 30 is a plan view of the handle device in FIG. 29;

FIG. 31 is a sectional view of the handle device in FIG. 29;

FIG. 32 is a perspective view of the handle device in FIG. 29 with a first housing portion removed;

FIG. 33 is an enlarged view of a partial region in FIG. 31;

FIG. 34 is an enlarged view of a partial region in FIG. 32;

FIG. 35 is a graph illustrating a variation curve of a motor speed when the speed is controlled according to a thrust in the related art;

FIG. 36 is a perspective view of a rear-moving, self-propelled working machine;

FIG. 37 is a sectional view of part of a structure of a handle device of the rear-moving, self-propelled working machine in FIG. 36;

FIG. 38A is a graph illustrating a relationship between an electrical signal of a pressure sensor of the rear-moving, self-propelled working machine in FIG. 36 and a thrust;

FIG. 38B is a graph illustrating a relationship between an electrical signal of a pressure sensor of the rear-moving, self-propelled working machine in FIG. 36 and a thrust;

FIG. 39 is a logic control diagram of the rear-moving, self-propelled working machine in FIG. 36;

FIG. 40 is another logic control diagram of the rear-moving, self-propelled working machine in FIG. 36;

FIG. 41 is a field-oriented control (FOC) diagram of whole machine control of the rear-moving, self-propelled working machine in FIG. 36; and

FIG. 42 is a flowchart of a method for whole machine control of the rear-moving, self-propelled working machine in FIG. 36.

### DETAILED DESCRIPTION

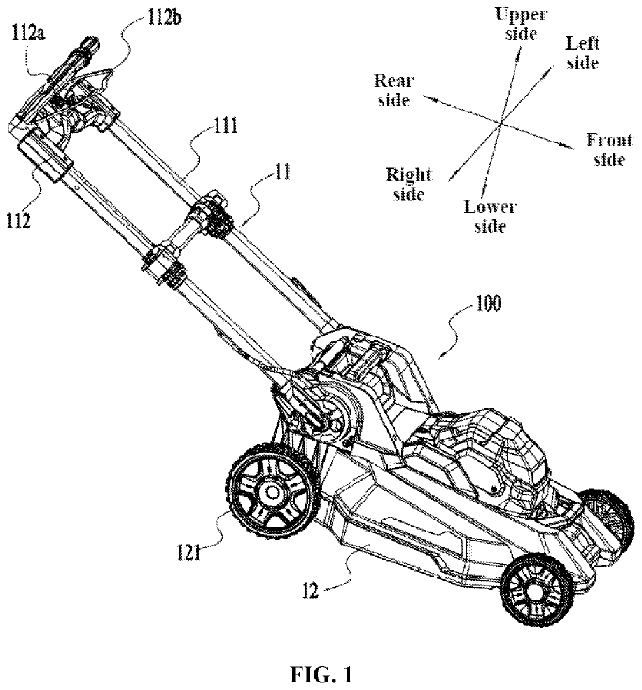

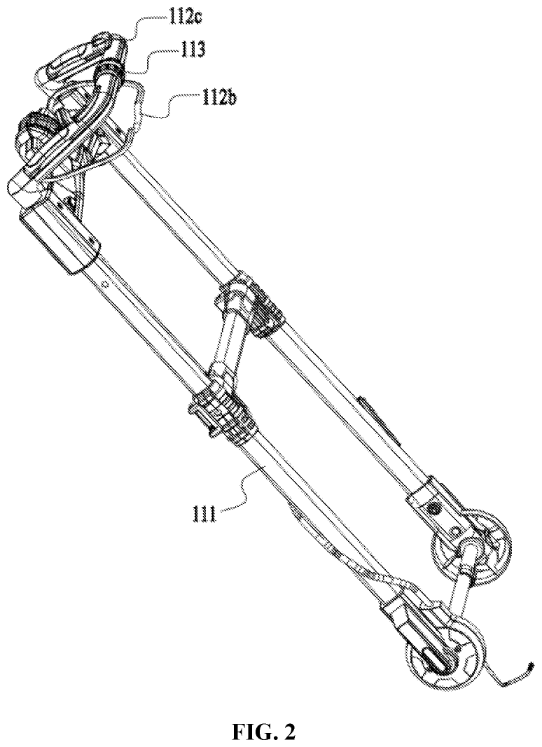

FIG. 1 illustrates a walk-behind, self-propelled working machine, also referred to herein as a rear-moving, self-propelled working machine, which may be a lawn mower, a snow thrower, a trolley, or other self-propelled working machines. As an optional example, the lawn mower is used. As shown in FIG. 1, a lawn mower 100 mainly includes a handle device 11 and a main body 12. The main body 12 includes a moving assembly 121 and a power mechanism. In one example, the lawn mower 100 is a hand-propelled lawn mower 100. The handle device 11 is connected to the main body 12 and used for a user to operate the lawn mower 100 on a rear side of the lawn mower 100. Other walk-behind, self-propelled working machines such as the snow thrower and the trolley may also include components such as the handle device 11, the main body 12, and the moving assembly 121. As shown in FIG. 2, the handle device 11 includes a connecting rod 111 and an operation member 112 that can be held. The operation member includes a gripping portion for the user to hold; the connecting rod 111 is a hollow long rod structure, and the connecting rod 111 connects the operation member 112 to the main body 12. The moving assembly 121 is installed on the main body 12 and can rotate around a rotation axis so that the entire lawn mower 100 can move on the ground.

To achieve a convenient operation and an effort-saving effect, the lawn mower 100 in this example also has a self-moving function. The power mechanism can drive the moving assembly 121 to rotate so as to drive the lawn mower 100 to move on the ground, so that the user does not need to manually push the lawn mower 100 to move. The power mechanism may be a drive motor 122 which can output a driving force for driving the moving assembly 121 to rotate. In one example, the user needs to operate a control switch separately to enable or disable the self-moving function. In fact, in some examples, a power button 112a, a trigger 112b, and an operation switch 112c of the lawn mower 100 are all integrated on the handle device 11. Exemplarily, the power button 112a, the trigger 112b, and the operation switch 112c of the lawn mower 100 are all integrated on the operation member 112. In addition, the operation switch 112c is not limited to a physical switch or a signal switch, and any device that can control a current in a circuit to be on or off is applicable. In fact, this type of operation switch 112c is not limited to current control and may also control the self-moving function to be enabled or disabled by mechanical means. To increase the convenience of a user operation, this example provides the lawn mower 100 which is convenient to operate and can automatically determine its self-moving speed according to a moving speed of the user and determine and control itself to be in a self-moving state or not according to an operation state of the user, that is, an adaptive mode is provided. This example further provides a manual speed regulation mode. Exemplarily, the lawn mower 100 includes a speed regulation switch disposed on the handle device 11 and used by the user to adjust a moving speed at which the walk-behind, self-propelled working machine moves on the ground. The operation switch 112c is further included, which is disposed on the handle device and configured to control the walk-behind, self-propelled working machine to switch between the adaptive mode and the manual speed regulation mode. The operation switch 112c includes a signal receiving member, where when the signal receiving member receives a switching signal, the signal receiving member controls the walk-behind, self-propelled working machine to perform mode switching. The switching signal includes a wireless signal or a wired signal. The switching signal is configured to be inputted through a smart voice or a mobile phone client. The operation switch 112c may also be configured to be a toggle switch or a control panel.

As shown in FIGS. 1 and 2, to clearly illustrate the technical solution of the present application, a front side, a rear side, a left side, a right side, an upper side, and a lower side shown in FIG. 1 are further defined. As a specific structure, the handle device 11 and the main body 12 form an active connection. Exemplarily, the handle device 11 and the main body 12 are rotatably connected and may be locked at a preset angle by a locking member. When operating the lawn mower 100 for a mowing operation, the user needs to push the lawn mower 100 to move. According to variables such as an amount of grass on the lawn and road conditions, the user needs to manually adjust the moving speed of pushing the lawn mower instead of mowing the grass mechanically according to the self-moving speed outputted by the lawn mower 100. If the user only controls the lawn mower 100 to move forward and cannot control the self-moving speed of the lawn mower 100 according to an actual situation, or the control of the self-moving speed of the lawn mower 100 requires a series of operations, the operating experience of the lawn mower 100 is greatly reduced. If complicated operations are involved, emergencies cannot be coped with, resulting in certain safety risks. As an implementation manner, the lawn mower 100 can automatically adjust the self-moving speed according to the moving speed of the user and can automatically cut off the power output of the drive motor 122 when the user stops moving forward. In one example, a sensing device 14 is disposed between the operation member 112 and the main body 12. The sensing device 14 may be specifically disposed on the main body 12 or may be disposed at a position where the operation member 112 and the main body 12 are connected or at any position between the operation member 112 and the main body 12. In this example, the sensing device 14 is disposed between the operation member 112 and the connecting rod 111. The sensing device 14 can output an electrical signal by sensing a thrust from the operation member 112. In fact, the sensing device 14 outputs a different electrical signal in response to a different thrust from the operation member 112.

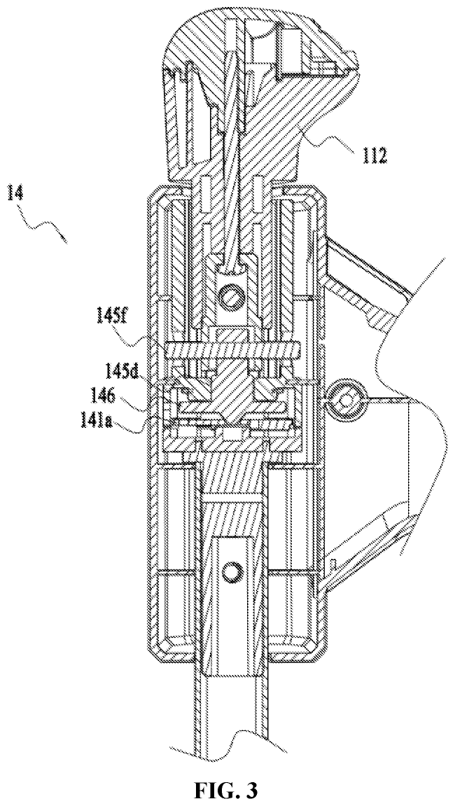

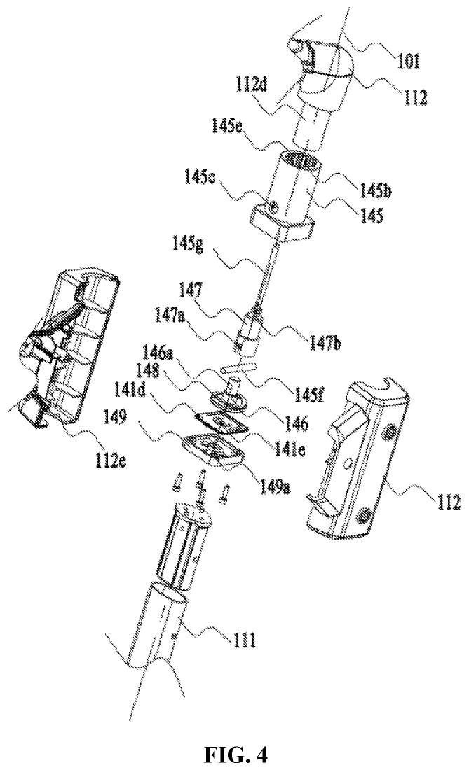

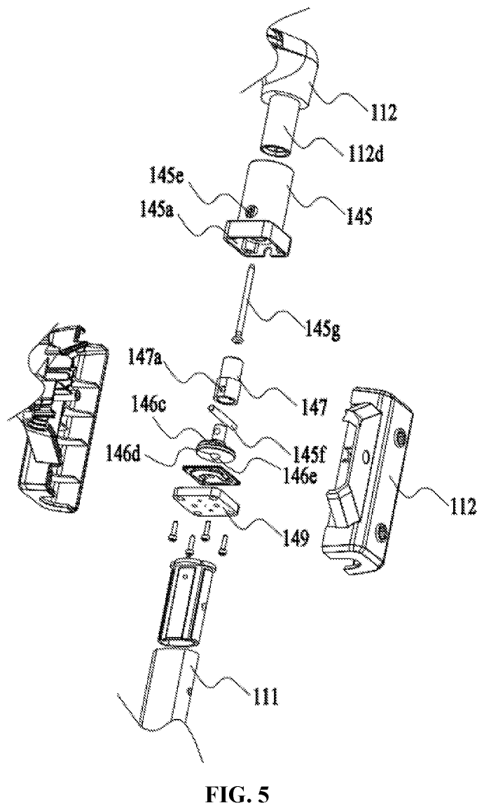

As shown in FIGS. 2 to 5, the operation member 112 is formed with an accommodation space 112e, and the sensing device 14 is disposed in the accommodation space 112e. The sensing device 14 includes a support member 145, a pressing member 146, and a sensor assembly 141. The support member 145 is formed with a first accommodation cavity 145a, and the pressing member 146 and the sensor assembly 141 are disposed at least partially in the first accommodation cavity 145a. The pressing member 146 may be operated to trigger the sensor assembly 141 so that the sensor assembly 141 can output an electrical signal. The sensor assembly 141 includes two pressure sensors 141a that are respectively disposed on left and right sides of the support member 145 and can feed back pressure values through strain and convert the pressure values into the electrical signals for calculation or to issue an indication signal. Within an interval where the sensing device 14 is located, an extension direction of the connecting rod 111 may be defined as a preset straight line 101, and the support member 145, the pressing member 146 and the sensor assembly 141 are sequentially arranged along the preset straight line 101. The sensing device 14 further includes an intermediate member 147 and a package 149. The intermediate member 147 is configured to connect the pressing member 146 to the operation member 112, and the package 149 is configured to close at least part of the first accommodation cavity 145a so that the pressing member 146 and the sensor assembly 141 can be fixed in the first accommodation cavity 145a. The operation member 112 further includes a connecting arm 112d formed along the preset straight line 101. The support member 145 further includes a second accommodation cavity 145b sleeved on the connecting arm 112d, the first accommodation cavity 145a and the second accommodation cavity 145b communicate at least partially with each other and allow the pressing member 146 to pass through. In one example, the intermediate member 147 is formed with a through hole, and the pressing member 146 is disposed at least partially in the through hole and connected to the intermediate member 147 through a first connecting member 145f. The intermediate member 147 is formed with a first connecting hole 147a for connecting the pressing member 146, and the pressing member 146 is formed with a second connecting hole 146a fitting with the first connecting hole 147a. The intermediate member 147 and the pressing member 146 are connected through the first connecting member 145f passing through the first connecting hole 147a and the second connecting hole 146a.

In fact, the support member 145 is further formed with a third connecting hole 145c fitting with the first connecting hole 147a and the second connecting hole 146a, that is, the first connecting member 145f passes through the first connecting hole 147a, the second connecting hole 146a, and the third connecting hole 145c at the same time. When the first connecting member 145f passes through the first connecting hole 147a, the first connecting member 145f has an interference fit with the first connecting hole 147a so that the intermediate member 147 will not be displaced along the preset straight line 101. A diameter of the second connecting hole 146a is greater than an outer diameter of the first connecting member 145f In this manner, when the pressing member 146 is connected to the intermediate member 147, the pressing member 146 and the intermediate member 147 may rotate relative to each other so that a force from the operation member 112 can be transmitted to the pressing member 146 and thus the pressing member 146 can press the sensor assembly 141, thereby deforming the sensor assembly 141. A ratio of a component of the thrust received by the gripping portion along the preset straight line 101 to a deformation amount of the pressure sensor 141a along the preset straight line 101 is greater than or equal to 40 N/mm and less than or equal to 1200 N/mm. Exemplarily, the ratio of the component of the thrust received by the gripping portion along the preset straight line 101 to the deformation amount of the pressure sensor 141a along the preset straight line 101 is greater than or equal to 150 N/mm and less than or equal to 300 N/mm. In this manner, the pressure sensor 141a can identify pressure more easily and output a more accurate pressure value. In one example, the intermediate member 147 further includes a fourth connecting hole 147b through which a second connecting member 145g can pass, and the fourth connecting hole 147b allows the second connecting member 145g to pass through so as to connect the intermediate member 147 to the connecting arm 112d. The connecting arm 112d is formed with a fifth connecting hole for the second connecting member 145g to be connected. When the second connecting member 145g is configured to be a screw, the fifth connecting hole is configured to be a screw hole fitting with the screw. In fact, the intermediate member 147 may also be connected to the connecting arm 112d in other manners, which are not repeated herein. As an implementation manner, the support member 145 may be provided as a separate part in the accommodation space 112e, or may be fixedly connected to or integrally formed with the connecting rod 111. When the support member 145 is configured to be fixedly connected to or integrally formed with the connecting rod 111, the connecting rod 111 is configured in two halves so that a sensor, the pressing member 146 and the like can be installed therein.

The pressing member 146 further includes a main body extending basically along the preset straight line 101, where a first end of the main body is formed with the preceding second connecting hole 146a, and a second end of the main body is formed with a limiting portion 146c and a triggering end 146d. The limiting portion 146c is configured to fit with the support member 145 to prevent the pressing member 146 from being disengaged from the support member 145. At the same time, the pressing member 146 is connected to the connecting arm 112d through the intermediate member 147. Therefore, when the limiting portion 146c fits with the support member 145, since a through hole 145d at a position where the first accommodation cavity 145a and the second accommodation cavity 145b of the support member 145 communicate with each other allows only the main body of the pressing member 146 to pass through and the limiting portion 146c disposed at one end of the main body cannot pass through the through hole 145d, the support member 145 is limited by the limiting portion 146c and basically generates no relative displacement with the connecting arm 112d. In one example, the sensing device 14 further includes a preload element 148, where the preload element 148 is disposed on a side of the limiting portion 146c facing away from the triggering end 146d. When the sensor assembly 141 and the pressing member 146 are disposed in the first accommodation cavity 145a and packaged by the package 149, the preload element 148 disposed between the limiting portion 146c and the support member 145 can provide a preload force. A signal value acquired by the sensor assembly 141 due to deformation is of a relatively small order of magnitude, and the signal value acquired by the sensor assembly 141 is generated through the deformation of the pressure sensor 141a. Within a preset interval, the pressure sensor 141a might be incapable of learning data, or even if the pressure sensor 141a learns data, the pressure sensor 141a cannot determine the accuracy of transmitted data, that is, signal values outputted by the pressure sensor 141a include values within a first interval and values within a second interval. The values within the first interval are composed of discrete data or nonlinear data and have a nonlinear relationship. The values within the second interval are data learnt after the pressure sensor 141a is compressed to a certain interval and have a linear relationship. The values within the first interval can be filtered out by a system only through complicated operations, and due to the nonlinear relationship of the data within the first interval, the entire system might perform inaccurate operations. The preload element 148 is provided to preload the pressure sensor 141a so that the values within the first interval can be directly and effectively filtered, and thus the pressure sensor 141a can output values that include a zero point value and have the linear relationship. In this manner, the system calculates data more conveniently and can obtain zero point data without multiple calibrations, thereby reducing a computing load of the system. The preceding preload element 148 is actually disposed on an upper side of the pressure sensor 141a. As another implementation manner, the preload element 148 may be disposed on a lower side of the pressure sensor 141a and can achieve basically the same effects as the preceding preload element 148 disposed on the upper side of the pressure sensor 141a, which are not repeated herein. The preload element 148 may be a pressure spring or other elastic members with elasticity, each of which can produce basically linear elastic deformation when receiving a force and return to an original position after the force is withdrawn.

The triggering end 146d further includes a driving surface 146e fitting with the sensor assembly 141 to apply pressure to the sensor assembly 141. The sensor assembly 141 further includes a force-receiving surface 141d that is in contact with the driving surface 146e to receive the pressure. A section of driving surface 146e in a plane parallel to the preset straight line 101 includes a section line, and a straight line where a line connecting two points on the section line is located obliquely intersects with the preset straight line 101. In fact, a plane where the driving surface 146e is located also obliquely intersects with the preset straight line 101. Therefore, when the driving surface 146e is pressed against the force-receiving surface 141d and the driving surface 146e is in contact with the force-receiving surface 141d, a projection of a contact surface between the driving surface 146e and the force-receiving surface 141d along the preset straight line 101 is still a circular plane, which can ensure that the pressure sensor 141a accurately learns a current pressure value and avoids a relatively complicated operation process. In fact, the triggering end 146d is configured to be a truncated cone, and the sensor assembly 141 is provided with a through hole 141e through which the truncated cone can at least partially pass, where a plane where the through hole 141e is located is the force-receiving surface 141d; and a side surface of the truncated cone is the driving surface 146e. In this example, the package 149 is further formed with or connected to a support portion 149a, where the support portion 149a is configured to fit with the sensor assembly 141 to support at least part of the sensor assembly 141 so that the following case is avoided: the sensor assembly 141 deforms too much and fails under the action of the pressing member 146. As another implementation manner, a section of the force-receiving surface 141d in the plane parallel to the preset straight line 101 includes a section line, and a straight line where a line connecting two points on the section line is located obliquely intersects with the preset straight line 101. In this case, the driving surface 146e is configured to be a plane surface, which can also achieve the following effect: when the driving surface 146e is in contact with the force-receiving surface 141d, the projection of the contact surface between the driving surface 146e and the force-receiving surface 141d along the preset straight line 101 is still the circular plane, which ensures that the pressure sensor 141a accurately learns the current pressure value and avoids the relatively complicated operation process.

A projection of a position of the support member 145 where the second accommodation cavity 145b is located on a first plane perpendicular to the preset straight line 101 includes a first length extending along a left-and-right direction and a second length extending along an up-and-down direction. The first length is greater than or equal to the second length. In one example, the first length is greater than the second length, and a difference obtained through subtraction of the second length from the first length is greater than or equal to 1 mm and less than or equal to 10 mm. In this manner, the connecting arm 112d and the operation member 112 are limited to a certain extent in the up-and-down direction and can shake to a certain extent in the left-and-right direction so that the following case is avoided: the support member 145 and the connecting arm 112d are stuck due to a friction therebetween, or the force cannot be effectively transmitted due to the friction. In one example, a projection of the second accommodation cavity 145b on the first plane is an ellipse. A major axis of the ellipse is arranged along the left-and-right direction and a minor axis of the ellipse is arranged along a front-and-rear direction. Exemplarily, along the preset straight line 101, the projection of the second accommodation cavity 145b of the support member 145 on the first plane has a first area, and a projection of the connecting arm 112d on the first plane has a second area. The first area is greater than the second area, and a ratio of the first area to the second area is greater than or equal to 1 and less than or equal to 3. In this manner, on the one hand, it is ensured that the connecting arm 112d can be effectively inserted into the second accommodation cavity 145b; and on the other hand, it is ensured that an inner wall of the second accommodation cavity 145b can at least partially limit the connecting arm 112d to avoid shaking between the operation member 112 and the support member 145 along the up-and-down direction when the operation member 112 is operated.

In addition, along the preset straight line 101, a rail portion 145e is formed around the inner wall of the second accommodation cavity 145b of the support member 145, that is, the inner wall of the second accommodation cavity 145b is not a continuous elliptic curve but is provided with bumps or grooves basically distributed uniformly so that when the connecting arm 112d is inserted into the second accommodation cavity 145b, a contact surface between the support member 145 and the connecting arm 112d is relatively small, a gap can be generated between the support member 145 and the connecting arm 112d, and thus a friction between the support member 145 and the connecting arm 112d is relatively small. In this example, a fixing member fitting with the package 149 is further included, where the fixing member may be fixed to the connecting rod 111 and fit with a housing of the operation member 112 to form the accommodation space 112e that can close and press the sensing device 14.

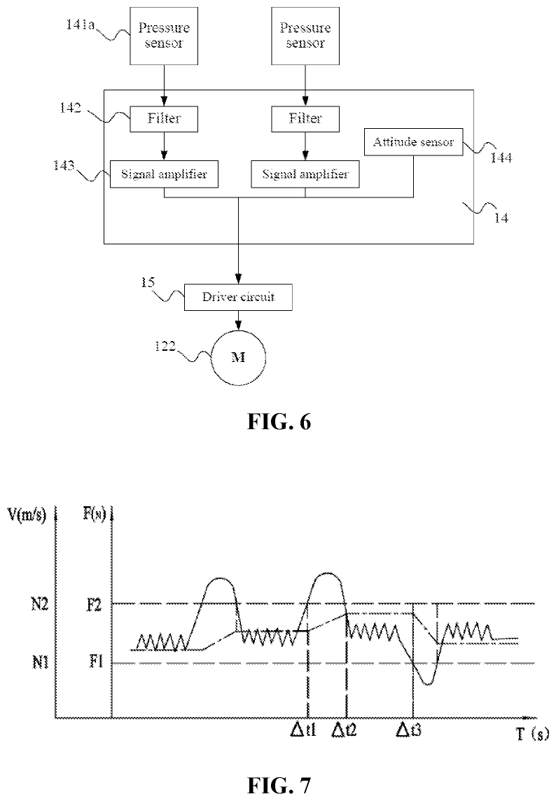

As shown in FIGS. 6 and 7, in this example, when the user operates the operation member 112, the sensing device 14 senses a force applied by the user to the operation member 112 and provides an electrical signal for determination. In one example, the sensing device 14 further includes a filter 142 and a signal amplifier 143. The sensor assembly 141 is configured to receive the pressure from the operation member 112 and output an electrical signal, the filter 142 is configured to filter the electrical signal outputted by the sensor assembly 141, and the signal amplifier 143 is configured to amplify the electrical signal filtered by the filter 142 to obtain the electrical signal for determination.

Due to various factors such as user habits and different operation conditions, a single sensor sometimes cannot accurately reflect a magnitude of pressure actually applied to the machine. To increase the sensitivity and accuracy of the sensor assembly 141 for receiving a pressure signal, the sensor assembly 141 may further include a first sensor and a second sensor. The first sensor and the second sensor are respectively disposed at two positions where the operation member 112 and the connecting rod 111 are connected. The first sensor is disposed at a left connection position of the operation member 112 and the connecting rod 111, and the second sensor is disposed at a right connection position of the operation member 112 and the connecting rod 111, where the left connection position and the right connection position may be located at the same position in a horizontal or vertical direction or at different positions in the horizontal or vertical direction. In fact, since the first sensor and the second sensor are installed at different positions and might be affected by the operation of the user, a difference between a first signal and a second signal inputted to the sensing device is relatively large, and the sensing device needs to superimpose signal values from the first sensor and the second sensor. In addition, in an actual operation process, the first signal inputted to the sensing device and the second signal inputted to the sensing device need to be calibrated, for example, weighted using different coefficients so that a total force inputted by the user can be accurately identified, thereby effectively avoiding erroneous determination when a single sensor is touched. On the other hand, the following case can be effectively avoided: the user who is accustomed to using the right hand or the left hand applies an unbalanced force on the operation member 112 and thus erroneous determination occurs. As another optional implementation manner, the sensor assembly 141 may also include only one sensor. A relatively smart sensor is disposed so that a signal is identified according to the operation of the user and a signal is outputted so as to control the self-moving function of the lawn mower 100. In one example, the preceding sensor may be disposed on a side of the operation member 112 and the connecting rod 111 or disposed at a position where the connecting rod 111 and the main body 12 are connected and can generate a signal for output through changes of the force applied to the connecting rod 111 or the main body 12 and the displacement, so as to control the self-moving function of the lawn mower 100 through the signal. In this example, the first sensor and the second sensor are specifically two identical pressure sensors 141a. The pressure sensors 141a may be contact pressure sensors or contactless pressure sensors.

In one example, when the triggering end 146d is in contact with the force-receiving surface 141d, the force-receiving surface 141d produces a certain amount of elastic deformation, and the amount of deformation is converted into an electrical signal for output. Due to different pressure received, the pressure sensor 141a may output a voltage signal proportional to the pressure and obtain a value of the thrust applied to a handle by the user according to the voltage signal so that the drive motor 122 is controlled to accelerate. When the user pushes the handle with different forces, the operation member 112 displaces at a level of a millimeter or less relative to the connecting rod 111 at the connection position, and the pressure sensor senses positive voltage signals substantially proportional to values of thrusts from the user so that a magnitude of a speed at which the drive motor 122 operates forward is controlled. It is to be noted that a distance between the force-receiving surface 141d of the pressure sensor 141a and the triggering end 146d of the lawn mower 100 at their initial positions is about 1 mm to 10 mm so that the appearance of the whole machine does not change at the position where the operation member 112 and the connecting rod 111 of the lawn mower 100 are connected, the relative displacement between the operation member 112 and the connecting rod 111 is relatively small, it is not easy for the user to notice that the operation member 112 and the connecting rod 111 of the lawn mower 100 are detachably connected or movably connected, and the whole machine has good user experience.

After the force-receiving surface 141d is triggered by the triggering end 146d, the amount of deformation of the pressure sensor 141a is of a relatively small order of magnitude, so a relatively weak electrical signal is outputted in such manner that the deformation is sensed. At this time, the electrical signal is amplified through a signal amplification circuit disposed in the handle device 11. In fact, before the pressure sensor 141a transmits the signal and the electrical signal is amplified, the electrical signal needs to be filtered. The electrical signal outputted by the pressure sensor 141a has noise clutter, where the clutter generally includes high-frequency and small-amplitude noise signals, abnormal pressure signals caused by accidental touch, and the like. In one example, a pre-filtering part is connected in the subsequent circuit connected to the pressure sensor 141a, a capacitor with a relatively small capacitance eliminates high-frequency noise, and a capacitor with a relatively large capacitance eliminates low-frequency noise. After the signal outputted by the pressure sensor 141a is filtered and amplified, a basically stable signal is outputted for determination.

The sensing device 14 further includes an attitude sensor 144, where the attitude sensor 144 is configured to collect spatial position signals of the lawn mower 100 and output a three-dimensional attitude and azimuth signal. In a process of operating the lawn mower 100 to mow the grass, when the lawn mower 100 needs to turn around, the user generally needs to lift a head of the lawn mower 100 and use rear wheels as a fulcrum to make it more convenient to turn around. In fact, the lawn mower 100 is still in operation during the process of turning the lawn mower 100 around, and the user is generally unaware of actively operating a control switch on the operation member 112 to shut down the lawn mower 100 so that the lawn mower 100 at this time has certain potential safety risks. The attitude sensor 144 is installed so that after detecting that the lawn mower 100 is lifted and has the tendency to turn around, the attitude sensor 144 outputs a signal to the sensing device 14, and the sensing device 14 outputs a stop signal so as to control the lawn mower 100 to brake or stop.

After receiving various signals, the sensing device 14 performs preliminary processing and can further output an electrical signal for determination, and the electrical signal is further transmitted to a driver circuit 15. The driver circuit 15 controls the drive motor 122 according to the signal transmitted from the sensing device 14. In one example, when the user turns on the operation switch 112c and pushes the lawn mower 100 to move forward, the thrust applied by the user to the operation member 112 has a relatively large value. At this time, the pressure sensor 141a transmits a relatively large electrical signal, and the sensing device 14 performs preliminary processing on the signal, that is, pressure signals from two pressure sensors 141a are filtered, amplified, and combined, and then transmitted to the driver circuit 15, and the driver circuit 15 controls, according to the electrical signal, the drive motor 122 to output a relatively large torque. When the user needs to decelerate according to an operation situation, the value of the thrust applied by the user to the operation member 112 becomes smaller, and the pressure sensor 141a transmits a relatively small electrical signal. After the signal is processed by the sensing device 14, the signal is then transmitted to the driver circuit 15, and the driver circuit 15 controls, according to the electrical signal, the drive motor 122 to output a relatively small torque. When the user does not touch the operation member 112 or is away from the operation member 112, the pressure sensor 141a no longer outputs an electrical signal, and the driver circuit 15 controls, according to a change in value of the electrical signal in the circuit, the self-moving drive motor 122 to stop rotating, so as to stop the lawn mower 100.

A rotational speed of the drive motor 122 is basically positively correlated to the moving speed of the user pushing the lawn mower 100. That is, when the moving speed of the user increases, the rotational speed of the self-moving drive motor 122 increases; when the moving speed of the user decreases, the rotational speed of the self-moving drive motor 122 decreases. When the circuit fluctuates or the electrical signal is unstable, a proportional relationship between the rotational speed of the drive motor 122 and the moving speed of the user is outside the preceding positive correlation, and the proportional relationship between the rotational speed of the drive motor 122 and the moving speed of the user is also considered as falling into the preceding positive correlation. A magnitude of the electrical signal outputted by the sensor assembly and an output torque of the self-moving drive motor 122 also form the positive correlation. When the accuracy of the sensing device 14 and the driver circuit 15 reaches a relatively high level, the rotational speed of the self-moving drive motor 122 may be positively proportional to the moving speed of the user.

When the user needs to lift the head of the lawn mower 100 and turn the lawn mower 100 around, the attitude sensor 144 detects the situation and outputs an electrical signal. The electrical signal is transmitted to the driver circuit 15 and the driver circuit 15 performs determination and controls the self-moving drive motor 122 of the lawn mower 100 to stop. When the user finishes turning the lawn mower 100 around and lays down the lawn mower 100, the driver circuit 15 of the lawn mower 100 is on and can enable the self-moving function and adjust the self-moving speed according to the moving speed of the user.

As another implementation manner, the walk-behind, self-propelled working machine further has a constant speed mode. The lawn mower 100 is used as an example. In this example, a driving manner of the lawn mower 100 can make it more convenient for the user to operate the lawn mower 100. In one example, as shown in FIGS. 6 and 7, when the user presses the operation switch 112c and the self-moving function of the lawn mower 100 is enabled, the lawn mower 100 enters a soft start stage in which the self-moving drive motor 122 provides the lawn mower 100 with an acceleration and the lawn mower 100 instantly enters a moving state from a stop state. Exemplarily, the soft start stage is very short, during which only the acceleration is provided to change the state of the lawn mower 100. When the user presses the operation switch 112c and pushes the lawn mower to move, the soft start stage has been completed and the lawn mower 100 enters the self-moving state. At this time, the lawn mower 100 controls the rotational speed or torque of the self-moving drive motor 122 according to the moving speed of the user, so as to control the self-moving speed. When the lawn mower 100 is pushed by the user, the pressure from the operation member 112 is received by the sensor assembly 141, and the lawn mower 100 is controlled to accelerate. When the user moves into a constant speed state adapted to the moving speed of the user and keeps outputting relatively stable pressure to the operation member 112 of the lawn mower 100, the lawn mower 100 enters a constant speed state adapted to the moving speed of the user.

As shown in FIG. 7, the lawn mower 100 is in the constant speed state within a preset pressure range. In one example, when the pressure received by the sensor assembly 141 is greater than or equal to F1 and less than or equal to F2, the lawn mower 100 enters the constant speed state adapted to the moving speed of the user according to a moving state of the user. Exemplarily, when the pressure received by the sensor assembly 141 is greater than or equal to F1 and less than or equal to F2, the moving speed of the lawn mower 100 is not positively correlated to the received force. When the user pushes the lawn mower 100 to move forward at a relatively fast speed, the sensor assembly 141 drives, according to the received force, the lawn mower 100 to move forward at the relatively fast speed. When the moving speed of the lawn mower 100 is synchronized with the moving speed of the user, the force applied by the user to the operation member 112 starts to decrease. However, since the user still needs to output part of the force to the operation member 112 to hold the operation member 112, the force transmitted to the sensor assembly 141 is reduced to a value between F1 and F2, and the sensing device 14 controls, according to a change of the force, the current moving speed of the lawn mower 100 to be constant. When different users push the lawn mower 100 to move forward and move at constant speeds which are different, the force applied by the user to the operation member 112 gradually decreases and falls between F1 and F2 when the user and the lawn mower 100 are moving at a constant speed, and the lawn mower 100 enters a constant speed state, where a speed at this time is the same as a moving speed at the previous moment. At this time, the user no longer needs to push the lawn mower 100 to move forward and only needs to place hands on the operation member 112 to follow the lawn mower 100 to move at a constant speed.

In addition, when the force transmitted to the sensor assembly 141 is greater than F2, the lawn mower 100 enters an acceleration state until the force falls within an interval greater than or equal to F1 and less than or equal to F2 again, and the lawn mower 100 enters the constant speed state again. When the force transmitted to the sensor assembly 141 is less than F1, the lawn mower 100 enters a deceleration state from the constant speed state. When the force transmitted to the sensor assembly 141 decreases to 0, the lawn mower 100 stops operating. F1 and F2 defined here do not limit a maximum moving speed and a minimum moving speed of the user. The user adjusts the relative movement with the lawn mower 100 according to the moving speed of the user, and when the force transmitted to the sensor assembly 141 falls between F1 and F2, the user keeps moving in a constant speed state at a speed the same as the speed at the previous moment. The constant speed at which the lawn mower 100 keeps moving is further limited to a speed range in which safe and effective mowing can be kept. That is, when the lawn mower 100 is operating at a high speed, the speed will not exceed a maximum speed N2 that threatens the safety of the user and is beyond the moving speed of the user; when the lawn mower 100 is operating at a low speed, the speed will not be lower than a minimum speed N1 that hinders the normal moving of the user and affects the mowing effect.

As an implementation manner, the lawn mower 100 further includes a controller, where the controller may be provided with a preset module, a conversion module, and a control module. The preset module is configured to set or store a preset thrust value. The preceding sensing device can periodically sense the value of the thrust applied to the handle device to drive the lawn mower 100. The conversion module can obtain a desired rotational speed according to the value of the thrust sensed by the sensing device and the thrust value set or stored in the preset module. The control module controls the rotational speed of the drive motor 122 to change toward the desired rotational speed.

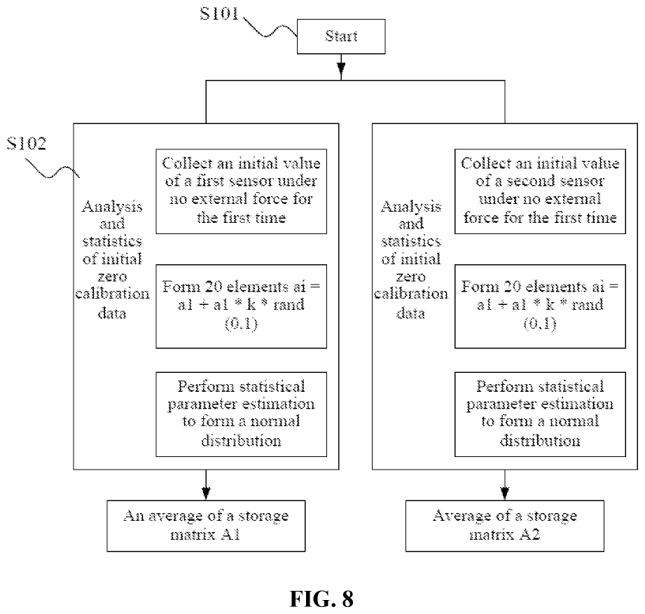

In one example, as shown in FIG. 8, the preset module, as a storage system of the lawn mower 100, can store a set of data in an initialization state. Exemplarily, the preset module separately records values of electrical signals of left and right sensors under no pressure, generates 20 initial elements a1 to a20 on a left side and 20 initial elements b1 to b20 on a right side through random rules, stores a1 to a20 and b1 to b20 in the preset module, and obtains an average of a storage matrix A1 and an average of a storage matrix A2. Furthermore, two sets of averages and standard deviations are obtained through statistical parameter estimation, so as to obtain two normal distributions of the left and right sensors and initialize the system.

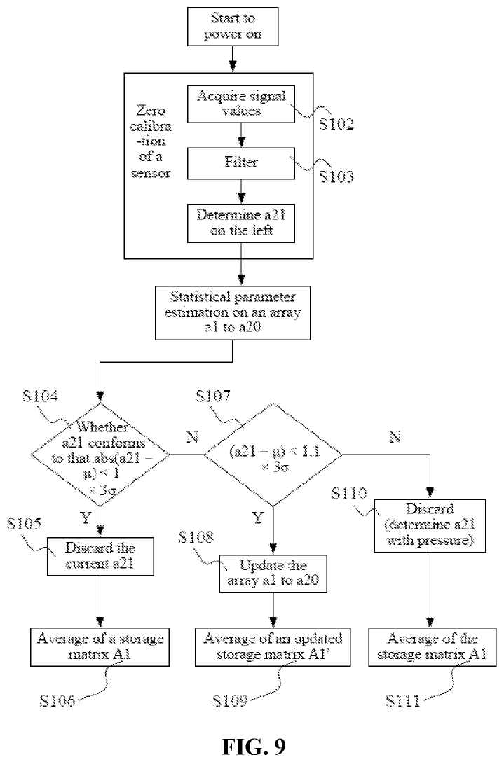

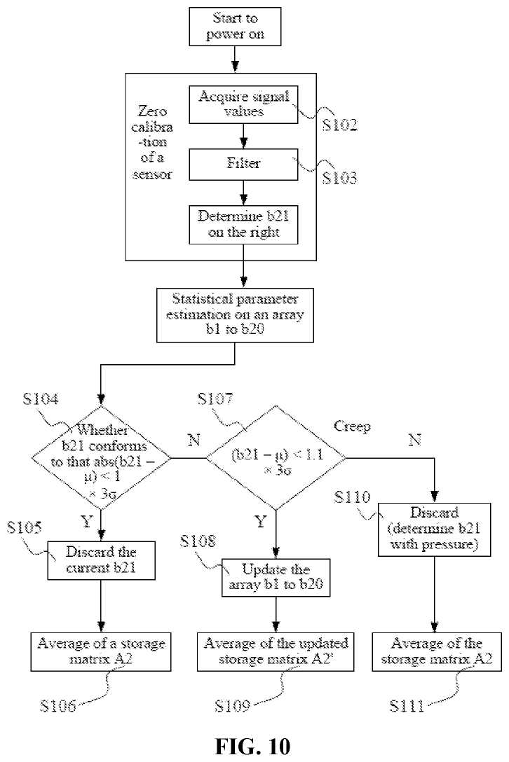

As shown in FIGS. 9 and 10, after the system is initialized, the lawn mower 100 can be operated normally. In one example, when the system is initialized, the left and right pressure sensors disposed on the operation member start to sense current pressure signal values as the sensing device. Here, the left pressure sensor is used as an example. When the pressure sensor senses pressure, the system filters the sensed pressure signal. After filtering, the system collects 100 filtered values and averages the 100 values to obtain a parameter a21. At this time, the normal distribution stored on the left side is called so as to determine whether the parameter a21 falls within the normal distribution. If so, the current parameter a21 is discarded, the average of the storage matrix A1 is called, and the storage matrix A1 is obtained; if not, a determination process according to a creep calibration rule starts. The lawn mower 100 further includes a correction module, where the creep calibration rule is set in the correction module, and the correction module is configured to correct a value of an initial output signal when the initial output signal sensed by the sensing device does not conform to the preceding normal distribution. In one example, the creep calibration rule is used for determining whether the current parameter a21 satisfies:

(a21−μ)<1.1×3σ (1)

where μ denotes a mathematical expectation of the normal distribution stored in the preset module, and σ denotes a standard deviation of the normal distribution stored in the preset module. When the parameter a21 satisfies the creep calibration rule, the initial elements a1 to a20 on the left side are updated to a2 to a21. The updated initial elements form an updated storage matrix A1′, and the updated storage matrix A1′ is averaged. Furthermore, a set of updated averages and standard deviations are obtained through statistical parameter estimation. At this time, the normal distribution stored on the left side is updated, and the system calls the average of the updated storage matrix A1′ and obtains the storage matrix A1′. When the parameter a21 does not satisfy the creep calibration rule, the current parameter a21 is discarded, the average of the original storage matrix A1 is called, and the storage matrix A1 is obtained.

As shown in FIG. 10, the right pressure sensor obtains an average of a real storage matrix in the same manner. In one example, when the pressure sensor senses pressure, the system filters the sensed pressure signal. After filtering, the system collects 100 filtered values and averages the 100 values to obtain a parameter b21. At this time, the normal distribution stored on the left side is called so as to determine whether the parameter b21 falls within the normal distribution. If so, the current parameter b21 is discarded, the average of the storage matrix A2 is called, and the storage matrix A2 is obtained; if not, a determination process according to a creep calibration rule starts. In one example, the creep calibration rule is used for determining whether the current parameter b21 satisfies:

(b21−μ)<1.1×3σ (2)

where μ denotes a mathematical expectation of the normal distribution stored in the preset module, and σ denotes a standard deviation of the normal distribution stored in the preset module. When the parameter b21 satisfies the creep calibration rule, the initial elements b1 to b20 on the left side are updated to b2 to b21. The updated initial elements form an updated storage matrix A2′, and the updated storage matrix A2′ is averaged. Furthermore, a set of updated averages and standard deviations are obtained through statistical parameter estimation. At this time, the normal distribution stored on the left side is updated, and the system calls the average of the updated storage matrix A2′ and obtains the storage matrix A2′. When the parameter b21 does not satisfy the creep calibration rule, the current parameter b21 is discarded, the average of the original storage matrix A2 is called, and the storage matrix A2 is obtained. Here, the creep calibration rule is set so that the following case can be effectively avoided: after the pressure sensor creeps, data called by the system cannot satisfy an actual accuracy requirement of the current pressure sensor. The creep calibration rule is set so that the pressure sensor can provide accurate data in real time. The averages of the real storage matrices acquired for the left and right pressure sensors are averaged so that a real-time thrust value of the pressure sensors is obtained.

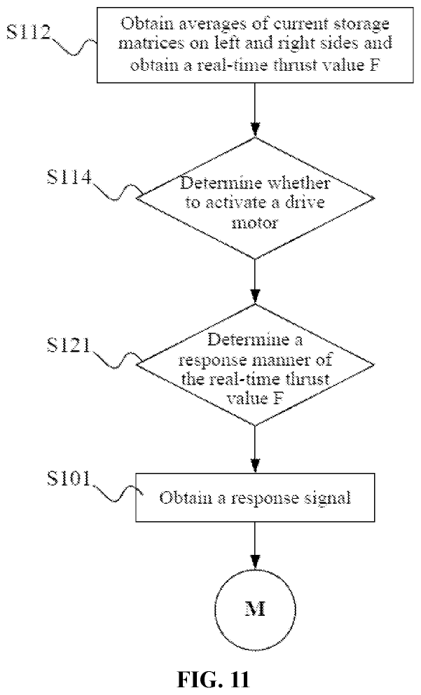

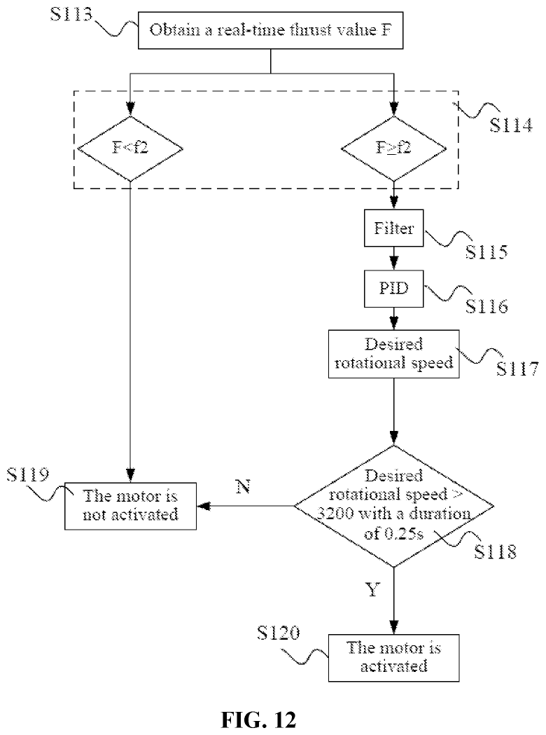

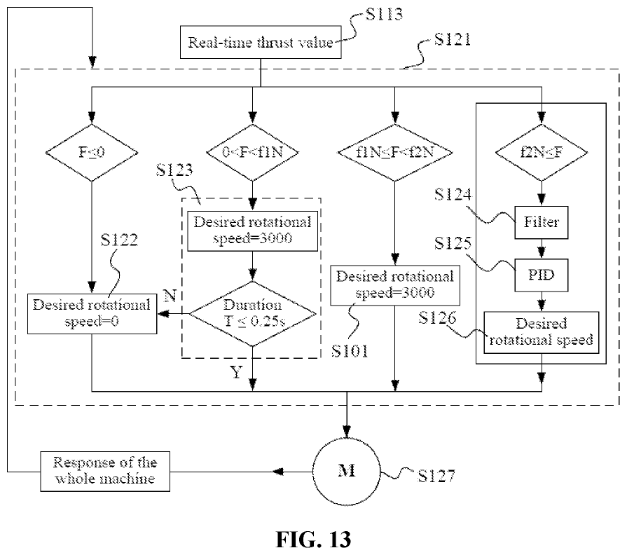

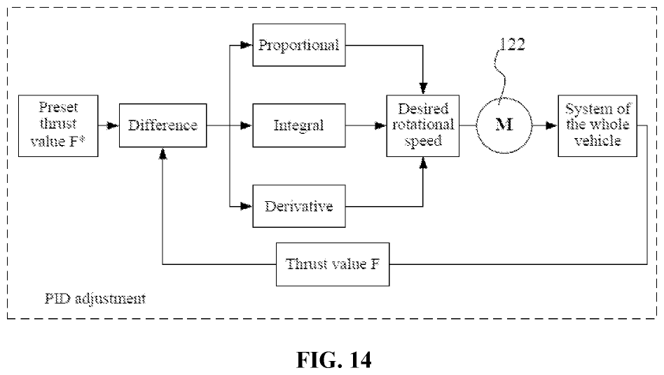

As shown in FIGS. 11 to 14, as an implementation manner, the lawn mower 100 in the present application includes a low-speed driving mode and an adaptive mode. When the value of the thrust received by the sensing device is less than a first preset value f1, the lawn mower 100 is in the low-speed driving mode; when the thrust value is greater than a second preset value f2, the lawn mower 100 is in the adaptive mode. Here, the preset module is further configured to set or store a preset speed. In the case where the walk-behind, self-propelled working machine is in the low-speed driving mode, the control module controls the rotational speed of the drive motor 122 to be less than or equal to a preset rotational speed; and in the case where the walk-behind, self-propelled working machine is in the adaptive mode, the control module controls the rotational speed of the drive motor 122 to change toward the desired rotational speed obtained according to the thrust value, where the desired rotational speed is greater than the preset rotational speed. In one example, the first preset value f1 is less than or equal to the second preset value f2. When the first preset value f1 is equal to the second preset value f2, the walk-behind, self-propelled working machine is configured to include only the low-speed driving mode and the adaptive mode. When the first preset value f1 is less than the second preset value f2, the walk-behind, self-propelled working machine is configured to further include the low-speed driving mode and the adaptive mode. When the thrust value is greater than the second preset value f2, the lawn mower 100 is in the adaptive mode; when the thrust value is greater than 0 and less than f2, the lawn mower 100 is in the low-speed driving mode; where when the thrust value is greater than or equal to f1 and less than f2, the lawn mower 100 is in the low-speed driving mode, and the drive motor 122 keeps rotating at a speed less than or equal to the preset rotational speed. When the thrust value is greater than 0 and less than f1, the drive motor 122 has a tendency to keep rotating at the speed less than or equal to the preset rotational speed. The conversion module determines the rotational speed of the drive motor 122 according to a duration of the value of the thrust sensed by the sensing device. That is, when the value of the thrust sensed by the sensing device is greater than 0 and less than f1 and the duration is less than or equal to a preset duration T, the control module controls the drive motor 122 to still keep rotating at the speed less than or equal to the preset rotational speed; and when the value of the thrust sensed by the sensing device is greater than 0 and less than f1 and the duration is greater than the preset duration T, the control module controls the drive motor 122 to stop.

The above provides only a process of determining the lawn mower 100 between the low-speed driving mode and the adaptive mode. In fact, when the lawn mower 100 is operated, the value of the thrust applied to the operation member is continuously sensed by the sensing device. The sensing device continuously determines a sensed real-time thrust value according to the preceding determination process, so as to control the lawn mower 100 to adjust its own operation condition in real time according to the real-time thrust value. That is, after the drive motor 122 obtains the current rotational speed, the whole machine responds and is controlled to move at the current rotational speed. When the control module obtains the next rotational speed, the control module immediately controls the drive motor 122 to perform a response of the whole machine according to the next rotational speed. When the value of the thrust applied to the lawn mower 100 is 0, or the lawn mower 100 is pulled backward, the value of the thrust sensed by the sensing device is less than or equal to 0, and the control module controls the rotational speed of the drive motor 122 to be 0. Exemplarily, since the sensing device is provided with a pre-compression element, where the pre-compression element is in a pre-compression state so that the pressure sensor in the pre-compression state. When the operation member of the lawn mower 100 is pulled backward, a pre-compression force applied to the pressure sensor is at least partially removed, and the pressure sensor outputs a negative value, that is, the thrust value outputted by the sensing device is less than or equal to 0.

When the lawn mower 100 moves by itself on the ground or a road with a relatively small friction, the user only needs to output a relatively small thrust value to push the lawn mower 100 to move. At this time, the value of the thrust sensed by the sensing device remains greater than 0 and less than f2, and the control module controls the drive motor 122 to keep rotating at the speed less than or equal to the preset rotational speed. The user may remain in a relatively comfortable state to push the lawn mower 100 to move. When the user needs to actively accelerate the lawn mower 100, the user quickly pushes the lawn mower 100 to move. At this time, under the action of acceleration, the force applied by the user to the operation member might be greater than or equal to f2 within a certain period of time. In this case, the conversion module can obtain the desired rotational speed according to the value of the thrust sensed by the sensing device and the thrust value set or stored in the preset module, and the control module controls the rotational speed of the drive motor 122 to change toward the desired rotational speed.

When the lawn mower 100 moves by itself on the ground or a lawn with a relatively large friction, the user needs to output a relatively large thrust value to push the lawn mower 100 to move due to the relatively large friction applied to the moving assembly 121. That is, the force applied to the operation member is greater than or equal to f2, the conversion module can obtain the desired rotational speed according to the value of the thrust sensed by the sensing device and the thrust value set or stored in the preset module, and the control module controls the rotational speed of the drive motor 122 to change toward the desired rotational speed. Exemplarily, when the value of the thrust sensed by the sensing device is greater than or equal to f2, the conversion module filters the current thrust value and then adjusts the filtered thrust value to obtain the desired rotational speed. As an implementation manner, a conversion process of the conversion module may be PID adjustment. In one example, a preset thrust value F* is set or stored in the preset module, where the preset thrust value F* may be set to a fixed value and may be configured to be selected within a preset interval. A difference between the preset thrust value F* and the thrust value obtained in real time is calculated so as to obtain a value, and proportional, integral, and derivative operations are performed on the value so as to obtain the desired rotational speed. The control module controls the motor to operate at the desired rotational speed in real time. The desired rotational speed is greater than the preset rotational speed. The preceding PID adjustment only reflects one adjustment process. In fact, when the user is operating the lawn mower 100, the sensing device continuously senses the value of the thrust applied to the operation member, and the conversion module also continuously performs conversions according to the value of the thrust. When the value of the thrust is greater than or equal to f2, the system continuously performs the PID adjustment until the moving speed of the user and the self-moving speed of the lawn mower 100 reach a dynamic balance, that is, the moving speed of the user is basically the same as the self-moving speed of the lawn mower 100. Exemplarily, in the preceding PID adjustment process, the value of the thrust sensed by the sensing device cannot reflect the real-time rotational speed of the drive motor 122 through the PID adjustment with certainty. Generally speaking, when a signal of the desired rotational speed is transmitted to the drive motor 122 and the drive motor 122 responds to the current signal to change its rotational speed, a response time difference exists, that is, the duration from when the sensing device senses the current thrust value to when the desired rotational speed is obtained through the PID adjustment is relatively short, and a speed at which the desired rotational speed is obtained and a speed at which the signal is transmitted are much greater than a response speed of the drive motor 122. However, the existence of the response time difference does not affect the operation of the lawn mower 100. To prevent the drive motor 122 from being unable to respond in time due to too fast a speed at which the desired rotational speed is acquired, the sensing device is configured to sense the current thrust value and sense the next thrust value 0.04 s later. In this process, although a duration from when the sensing device senses a current pressure value to when the conversion module completes the conversion of the current thrust value and obtains the desired rotational speed is much shorter than 0.04 s, the sensing device no longer senses the thrust value and restarts to sense a current thrust value 0.04 s later and transmits the current thrust value to the conversion module for conversion, so as to obtain a new desired rotational speed. After a series of PID adjustment processes, the moving speed of the user and the self-moving speed of the lawn mower 100 tend to be the same, and the preceding response time difference disappears immediately.

The preset rotational speed is a rotational speed preset in the system for reference, and the desired rotational speed is a rotational speed that an operator expects the drive motor 122 to reach during operation. As an implementation manner, the preceding values may be set to the following data: for example, the preset rotational speed in the preset module of the lawn mower 100 is set to 3000 r/min, the first preset value f1 is set to 10 N, and the second preset value is set to 17 N. The preset duration T is set to 0.25 s, and the preset thrust value F* may be selected within an interval greater than or equal to 10 N and less than or equal to 60 N. In one example, the preset thrust value F* may be selected within an interval greater than or equal to 20 N and less than or equal to 30 N. When the value of the thrust received by the sensing device is less than or equal to 0 N, the control module controls the rotational speed of the drive motor 122 to be 0; when the value of the thrust received by the sensing device is greater than 0 N and less than or equal to 10 N, it is determined whether the duration of the thrust value is less than or equal to 0.25 s, where when the duration is less than or equal to 0.25 s, the control module controls the drive motor 122 to rotate at a speed less than or equal to 3000 r/min, and when the duration is greater than 0.25 s, the control module controls the rotational speed of the drive motor 122 to be 0. When the value of the thrust received by the sensing device is greater than or equal to 10 N and less than or equal to 17 N, the control module controls the rotational speed of the drive motor 122 to be less than or equal to 3000 r/min. When the value of the thrust received by the sensing device is greater than or equal to 17 N, the conversion module can obtain the desired rotational speed through filtering and PID adjustment according to the value of the thrust sensed by the sensing device, and the control module controls the drive motor 122 to rotate at the desired rotational speed greater than 3000 r/min until the value of the thrust from the user is stabilized within the interval greater than or equal to 20 N and less than or equal to 30 N and the lawn mower 100 operates at a speed that allows the user to move comfortably. In one example, the preset rotational speed, f1, f2, and T are not limited to the preceding values, and only an optional example is provided here for reference.

In this example, before determining whether the lawn mower 100 enters the low-speed driving mode or the adaptive mode, the system needs to determine, according to the real-time thrust value, whether the drive motor 122 is activated. In one example, when the real-time thrust value is less than the second preset value f2 in the preset module, the motor is not activated. When the real-time thrust value is greater than or equal to the second preset value f2, the system filters the acquired real-time thrust value and then performs the PID adjustment on the filtered value to obtain a motor target value. Here, the preset module further stores a preset rotational speed for start-up. When the motor target value is greater than the preset rotational speed for start-up and a duration is greater than 0.25 s, the motor is activated and the system enters a mode determination process of the low-speed driving mode or the adaptive mode. Otherwise, the motor is not activated.

The present application further provides a method for a walk-behind, self-propelled working machine. The method includes steps described below.

In S101, the lawn mower starts to be powered on. Then, S102 is performed. That is, the lawn mower 100 is connected to a power source, and a power switch is in an on stage.

In S102, electrical signals are collected. Then, S103 is performed. At this time, the sensing device disposed inside the operation member starts to collect pressure signals under the action of an external force. For example, the first sensor collects 100 electrical signals; and the second sensor collects 100 electrical signals.

In S103, filtering is performed. Then, S104 is performed. When the pressure signals are collected, the system starts to filter the collected pressure signals, that is, to filter out some noise clutter. When the filtering is completed, the system collects 100 filtered values on the left and 100 filtered values on the right, averages them, and determines a21 and b21.

In S104, whether a21 conforms to a normal distribution in an initial state is determined. If so, S105 is performed; and if not, S107 is performed.

In S105, the current value a21 is discarded. Then, S106 is performed.

In S106, the normal distribution of a storage matrix A1 in the initial state is not updated; and an average of the current storage matrix A1 on the left side is obtained.

In S107, whether the current value a21 conforms to the creep calibration rule. If so, S108 is performed; and if not, S110 is performed.

In S108, the storage matrix is updated. Then, S109 is performed.

In S109, an average of the updated storage matrix A1′ is obtained.

In S110, the current value a21 is discarded. Then, S111 is performed.

In S111, the normal distribution of the storage matrix A1 in the initial state is not updated; and the average of the current storage matrix A1 on the left side is obtained.

A manner for determining b21 is the same as the manner for determining a21. The preceding determination process from S104 to S111 is the same for b21.

In S112, the average of the current storage matrix on the left side and the average of the current storage matrix on the right side are obtained. Then, S113 is performed.

In S113, a real-time thrust value F is obtained. Then, S114 is performed.

In S114, whether to activate the drive motor 122 is determined according to the real-time thrust value F. If F<f2, S119 is performed; and if F≥f2, S115 is performed.

In S115, when the thrust value F is collected, the system starts to filter the thrust value F, that is, to filter out some noise clutter. After the filtering is completed, S116 is performed.

In S116, PID conversion is performed. Then, S117 is performed.

In S117, the desired rotational speed Pre-speed of the drive motor 122 is obtained. Then, S118 is performed.

In S118, whether the desired rotational speed Pre-speed of the drive motor 122 is greater than 3200 and lasts for 0.25 s is determined. If not, S119 is performed; and if so, S120 is performed.

In S119, the drive motor 122 is not activated.

In S120, the drive motor 122 is activated. Then, S121 is performed.

In S121, a response manner of the thrust is determined according to the real-time thrust value F. If F≤0, S122 is performed; if 0<F<f1, S123 is performed; if f1<F≤f2, S124 is performed; if f2≤F, S125 is performed.

In S122, the drive motor 122 outputs a rotational speed of 0. That is, the drive motor 122 is in a braking state.

In S123, the drive motor 122 outputs a rotational speed of 3000 r/min, and whether the output continues for 0.25 s is determined. If so, S122 is performed; and if not, S127 is performed.

In S124, the system starts to filter the thrust value F, that is, to filter out some noise clutter. After the filtering is completed, S125 is performed.

In S125, the PID conversion is performed. Then, S126 is performed.

In S126, the desired rotational speed Pre-speed of the drive motor 122 is obtained. Then, S127 is performed. In this case, a process in which the speed of the drive motor 122 follows the Pre-speed of the drive motor 122 exists.

In S127, the drive motor 122 responds and the whole machine responds. Then, S121 is performed.

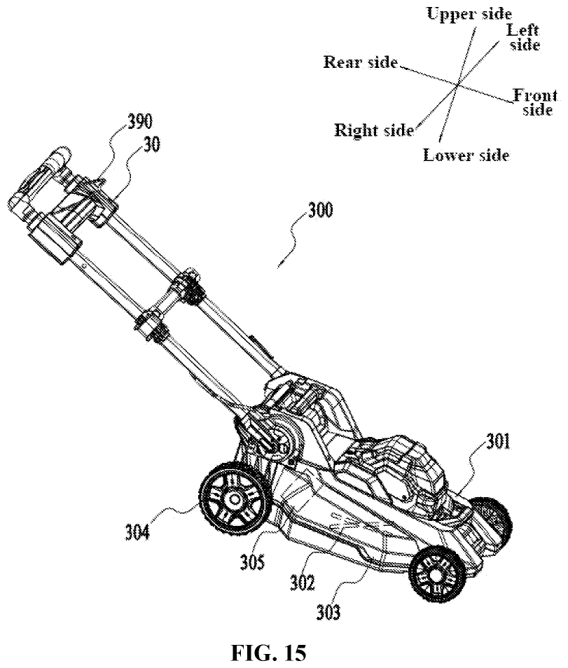

In some related lawn mowers with a self-moving function, the self-moving function requires manual control, only a constant speed can be outputted, and a user can only follow a lawn mower and perform a mowing operation. If a moving speed of the user is less than a moving speed of the lawn mower, the user may feel pulled by the lawn mower. If the moving speed of the user is greater than the moving speed of the lawn mower, the user may feel hindered by the lawn mower. To sum up, the comfort of the user during mowing is reduced. To solve the preceding problems, this example provides a rear-moving, self-propelled working machine as shown in FIG. 15 and specifically, a lawn mower 300 for mowing lawns. In other examples, the rear-moving, self-propelled working machine may be another self-propelled working machine such as a snow thrower or a trolley.

As shown in FIG. 15, the lawn mower 300 includes a main machine 301 and a handle device 30. The main machine 301 includes a blade assembly 302, a chassis 303, a moving assembly 304, and a motor 305. The blade assembly 302 is used for implementing a cutting function. The chassis 303 is used for accommodating the blade assembly 302. The moving assembly 304 supports the chassis 303. The motor 305 is used for driving the blade assembly 302 to rotate and can also drive the moving assembly 304 to rotate.

The handle device 30 is connected to the main machine 301, and the handle device 30 is connected to a rear end of the main machine 301. The handle device 30 is used for the user to operate. The handle device 30 can also rotate relative to the main machine 301 so as to adapt to users with different heights. The handle device 30 can also rotate relative to the main machine 301 to a folded state. In this case, the lawn mower 300 occupies a relatively small space, thereby facilitating the storage of the lawn mower 300.

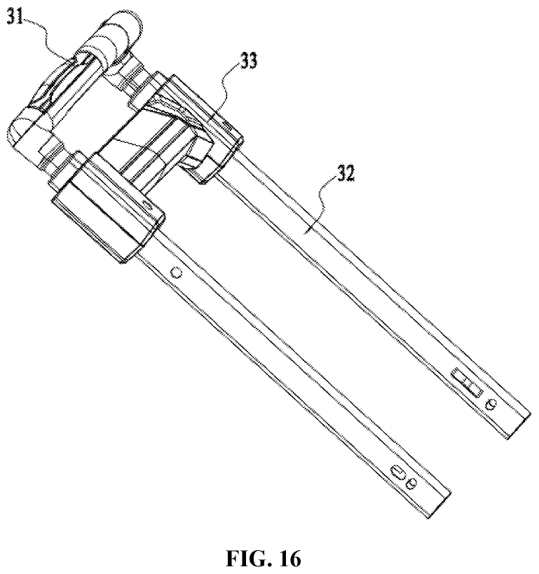

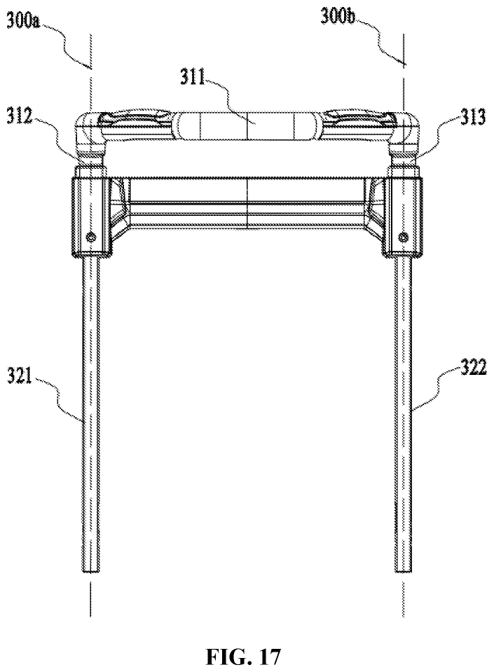

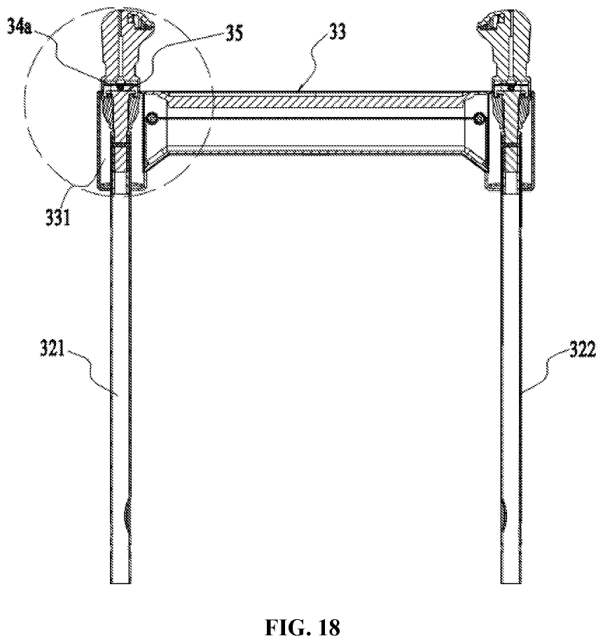

As shown in FIGS. 15 to 20, the handle device 30 includes an operation member 31, a connecting rod assembly 32, a housing 33, a sensing device 34a, a trigger assembly 35, and a preload element 36, where the sensing device 34a includes a pressure sensor 34. The operation member 31 includes a grip 311, a first mounting portion 312, and a second mounting portion 313, where the grip 311 is used for the user to hold, and the first mounting portion 312 and the second mounting portion 313 are disposed at two ends of the grip 311, separately. In this example, the first mounting portion 312 extends along a first straight line 300a, and the second mounting portion 313 extends along a second straight line 300b parallel to the first straight line 300a. When the user needs to push the lawn mower 300 for mowing, the user may stand on a rear side of the handle device 30 and hold the grip 311 by hand to apply a forward thrust to the grip 311 so that the lawn mower 300 can be driven to move on the ground.

The connecting rod assembly 32 is used for connecting the operation member 31 to the main machine 301. The connecting rod assembly 32 includes a first connecting rod 321 and a second connecting rod 322. An end of the first connecting rod 321 is connected to the main machine 301, and the other end of the first connecting rod 321 is connected to the first mounting portion 312. An end of the second connecting rod 322 is connected to the main machine 301, and the other end of the second connecting rod 322 is connected to the second mounting portion 313. The first connecting rod 321 extends along the first straight line 300a, and the second connecting rod 322 extends along the second straight line 300b parallel to the first straight line 300a.

The housing 33 extends along a left and right direction, and the housing 33 is connected to the first connecting rod 321 and the second connecting rod 322. The handle device 30 further includes a trigger 390 for starting the blade assembly 302, where the trigger 390 is rotatably connected to the housing 33. The housing 33 is formed with a first accommodation cavity 331, where the first connecting rod 321 extends into the first accommodation cavity 331 along the first straight line 300a. The housing 33 is also fixedly connected to the connecting rod assembly 32.

The pressure sensor 34 is used for sensing a thrust applied to the handle device 30 to drive the lawn mower 300 to move forward. In this example, the pressure sensor 34 is a resistance strain gauge sensor. In other examples, the pressure sensor may be a thin-film piezoelectric sensor or the pressure sensor may be a ceramic sensor. The trigger assembly 35 can apply a force to the pressure sensor 34 when the grip 311 receives the thrust, and the trigger assembly 35 can drive the pressure sensor 34 to deform. In this manner, when the user applies the thrust to the grip 311, the trigger assembly 35 applies the force to the pressure sensor 34, and the pressure sensor 34 is deformed and generates an electrical signal. The lawn mower 300 may further include a signal processing device and a controller. The electrical signal generated by the pressure sensor 34 is sent to the signal processing device, the signal processing device sends the processed signal to the controller, and the controller controls the lawn mower 300 to move on the ground. Moreover, the lawn mower 300 accelerates when the thrust applied by the user increases, and the lawn mower 300 decelerates when the thrust applied by the user decreases. When the user accelerates, the thrust applied by the user to the handle device 30 increases, and the controller controls a forward speed of the lawn mower 300 to increase. Similarly, when the user decelerates, the thrust applied by the user to the handle device 30 decreases, and the controller controls the forward speed of the lawn mower 300 to decrease. Therefore, the forward speed of the lawn mower 300 adapts to the moving speed of the user, and the phenomenon that the lawn mower 300 pulls the user to run does not occur, thereby improving the user's comfort.

In this example, a ratio of a component of the thrust received by the grip 311 along a direction of the first straight line 300a to a deformation amount of the pressure sensor 34 along the direction of the first straight line 300a is greater than or equal to 40 N/mm and less than or equal to 1200 N/mm. Alternatively, in other examples, the ratio of the component of the thrust received by the grip 311 along the direction of the first straight line 300a to the deformation amount of the pressure sensor 34 along the direction of the first straight line 300a is greater than or equal to 1200 N/mm and less than or equal to 5000 N/mm.

In this example, the pressure sensor 34 is connected to the operation member 31, and the trigger assembly 35 is connected to the connecting rod assembly 32. In this manner, the pressure sensor 34 and the operation member 31 constitute a first whole that moves together, and the trigger assembly 35 and the connecting rod assembly 32 constitute a second whole that moves together. In this manner, a position of the trigger assembly 35 with the connecting rod assembly 32 along the direction of the first straight line 300a remains unchanged, while the pressure sensor 34 moves with the operation member 31, thereby reducing the number of moving parts, facilitating the installation of the pressure sensor 34 and the trigger assembly 35, and simplifying the structure of the lawn mower 300. At the same time, the operation member 31 is likely to deform or shake in a working process, for example, positions of the first mounting portion 312 and the second mounting portion 313 change. At this time, the position of the trigger assembly 35 relative to the connecting rod assembly 32 along the direction of the first straight line 300a remains fixed so that the connecting rod assembly 32 can apply the force to the pressure sensor 34 relatively stably, thereby improving the detection accuracy of the pressure sensor 34 and making the lawn mower 300 still reliable after long-term use.

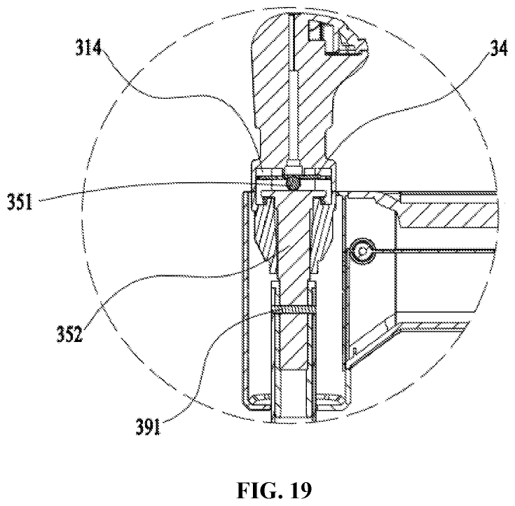

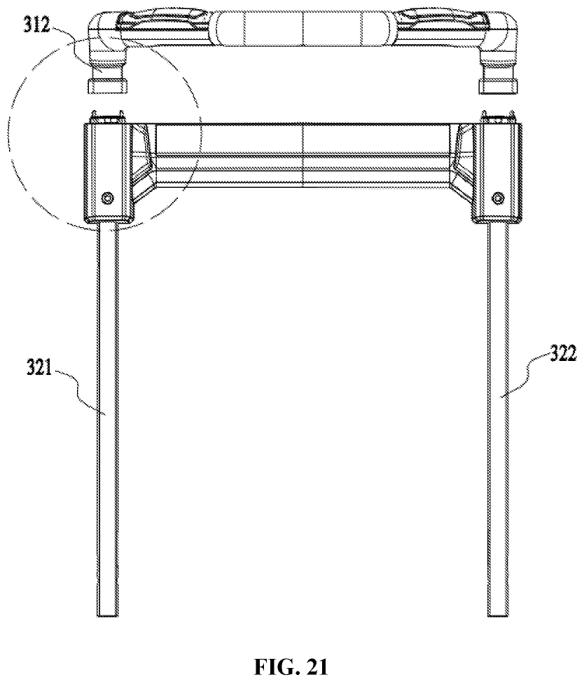

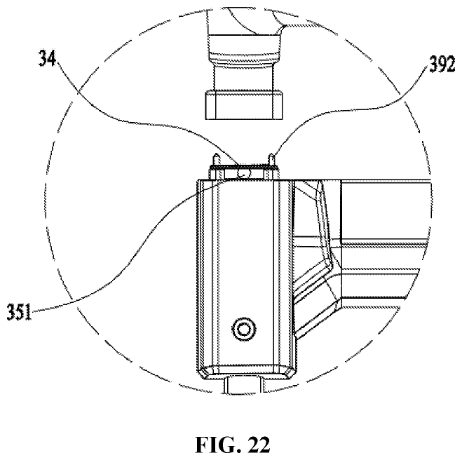

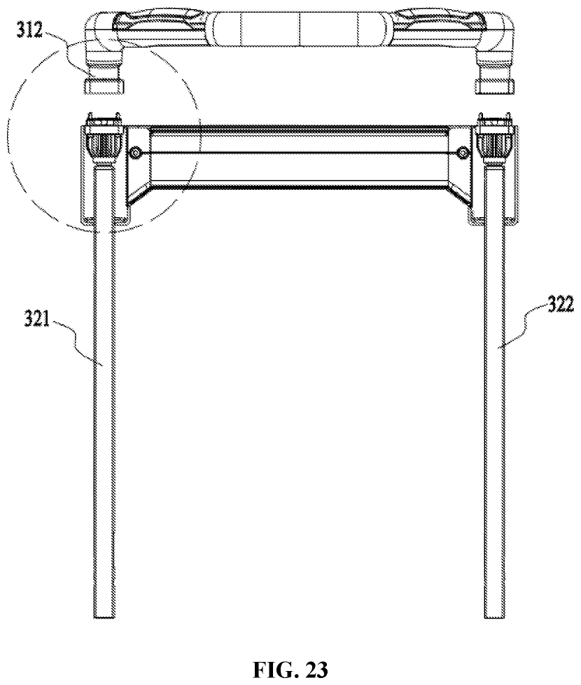

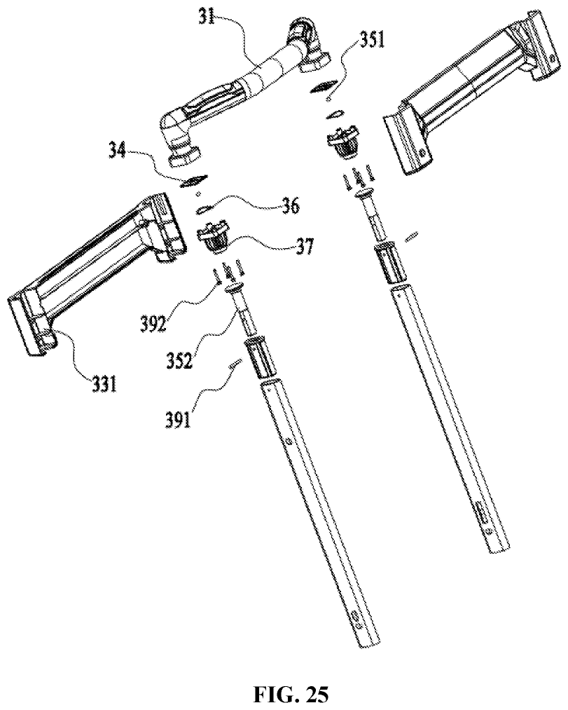

Specifically, as shown in FIGS. 19 to 25, in this example, the trigger assembly 35 includes a trigger piece 351 and a slider 352, where the trigger piece 351 is used for being in contact with the pressure sensor 34 to apply the force to the pressure sensor 34. The slider 352 is used for connecting the trigger piece 351 to the first connecting rod 321. In this example, the slider 352 and the trigger piece 351 are two different parts. In other examples, the slider 352 may be integrally formed with the trigger piece 351. In this example, the slider 352 is connected to the connecting rod assembly 32 through a connecting pin 391, where the connecting pin 391 extends along a direction perpendicular to the first straight line 300a.

The operation member 31 is formed with a second accommodation cavity 314, where the second accommodation cavity 314 is formed at an end of the first mounting portion 312 farther away from the grip 311. The second accommodation cavity 314 is open toward the connecting rod assembly 32, and the pressure sensor 34 is disposed in the second accommodation cavity 314. In this example, the pressure sensor 34 is mounted to the first mounting portion 312, and the pressure sensor 34 is fixedly connected to the first mounting portion 312 through screws 392. The trigger assembly 35 is mounted to the connecting rod assembly 32. Specifically, the slider 352 in the trigger assembly 35 is fixedly connected to the first connecting rod 321, and positions of the slider 352 and the trigger piece 351 along the direction of the first straight line 300a are synchronized. The pressure sensor 34 is disposed outside the housing 33, thereby facilitating the assembly of the pressure sensor 34. When the pressure sensor 34 is severely deformed after long-term use, or when the pressure sensor 34 fails in detection, the user can replace the pressure sensor 34 more conveniently. In other examples, the pressure sensor may be mounted to the connecting rod assembly, and the trigger assembly may be mounted to the first mounting portion.

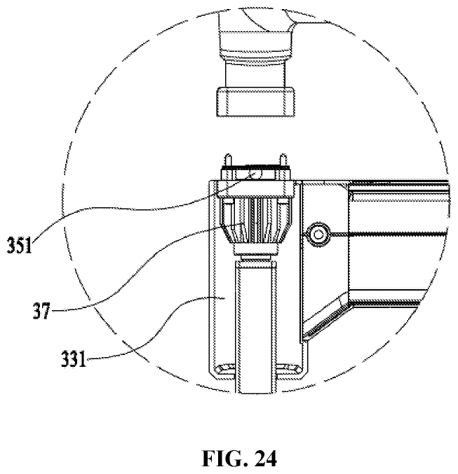

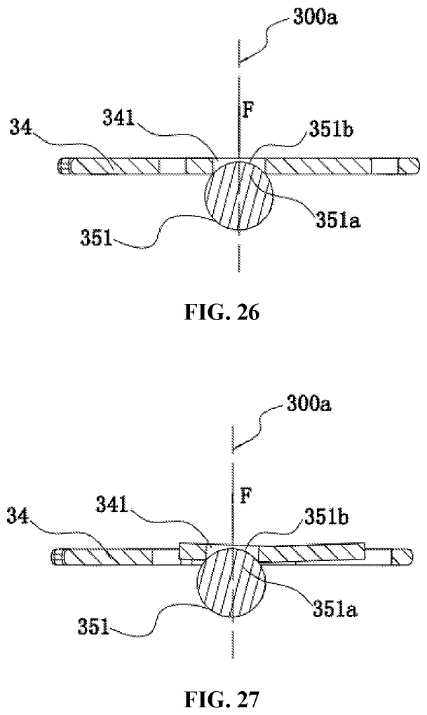

As shown in FIGS. 19, 22 and 24, the trigger piece 351 is at least partially disposed in the second accommodation cavity 314. As shown in FIGS. 24 to 27, the trigger piece 351 includes a trigger portion 351a, where the trigger portion 351a includes a triggering surface 351b for being in contact with the pressure sensor 34. In this example, the trigger piece 351 is a sphere, the trigger portion 351a is a sphere portion, and the triggering surface 351b is a spherical surface. A hole is formed on the pressure sensor 34, where the hole is specifically a through hole 341, and the spherical surface is embedded into the through hole 341 to be in contact with an edge of the through hole 341. In other examples, the hole formed on the pressure sensor and for being in contact with the trigger piece may be a blind hole. As shown in FIG. 26, when the trigger piece 351 is in contact with the pressure sensor 34 but applies no force or a relatively small force F to the pressure sensor 34, a position of the through hole 341 is basically unchanged, and the triggering surface 351b is in contact with the edge of the through hole 341 and applies the force F uniformly to a circle of the edge so that the force F applied by the trigger piece 351 to the pressure sensor 34 extends along the first straight line 300a. As shown in FIG. 27, when the force F applied by the trigger piece 351 to the pressure sensor 34 is relatively large, the pressure sensor 34 is deformed, and the through hole 341 changes in position but is still symmetric about a plane passing through the first straight line 300a so that the force F applied by the trigger piece 351 to the pressure sensor 34 still extends along the first straight line 300a. In this manner, the spherical surface on the trigger piece 351 is in contact with the through hole 341 so that the force F received by the pressure sensor 34 extends basically along the direction of the first straight line 300a, thereby improving the detection accuracy. It is to be noted that the sphere portion is part of a sphere. The sphere portion may be part of a standard sphere or may be part of a shape similar to a sphere, for example, the sphere portion is part of a shape similar to a duck egg. That is to say, the sphere portion is not strictly required to be part of a standard sphere in shape, and any solution that can basically achieve the preceding technical effect of improving the detection accuracy of the present application belongs to the protection scope of the present application.

In this example, an area of a projection of the triggering surface 351b on a plane perpendicular to the first straight line 300a is greater than an area of a projection of the through hole 341 on this plane. In this manner, even if the sphere rotates when the pressure sensor 34 is deformed, the triggering surface 351b is always in contact with the through hole 341 through the spherical surface. A projection of a part of the triggering surface 351b in contact with the through hole 341 on the plane perpendicular to the first straight line 300a is still symmetric about the first straight line 300a so that the force F applied by the triggering surface 351b to the pressure sensor 34 still extends along the first straight line 300a.

The pressure sensor 34 is connected to the operation member 31, the trigger piece 351 is disposed between the pressure sensor 34 and the connecting rod assembly 32, and along the direction of the first straight line 300a, a position of the trigger piece 351 relative to the connecting rod assembly 32 remains fixed so that a detection error caused by a displacement of the sphere can be further reduced. In other examples, the pressure sensor may be connected to the connecting rod assembly, the trigger piece is connected to the operation member, and the trigger piece is a sphere disposed between the operation member and the pressure sensor. In this case, a position of the pressure sensor relative to the connecting rod assembly along the direction of the first straight line remains fixed.

It is to be understood that the triggering surface 351b is at least part of a spherical surface. In this example, the triggering surface 351b is a complete spherical surface.

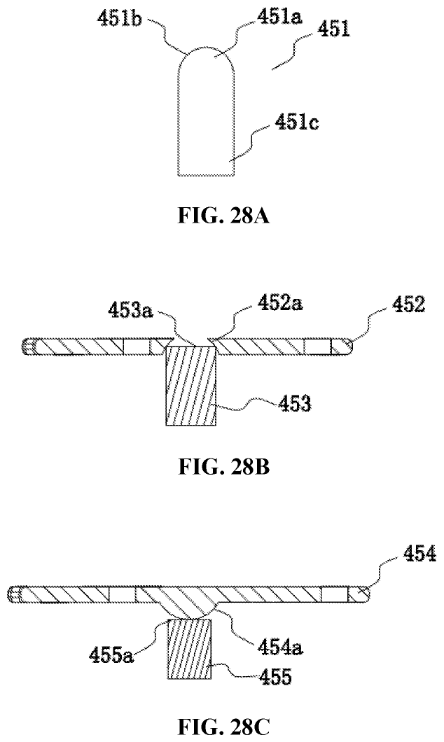

In other examples, the trigger piece may not be in the shape of a sphere. For example, in the example shown in FIG. 28A, a trigger piece 451 includes a main body 451c and a sphere portion 451a for being in contact with the pressure sensor, where the sphere portion 451a is part of a sphere, and a triggering surface 451b formed on the sphere portion 451a and used for being in contact with the pressure sensor is a semi-spherical surface. Similarly, it is to be understood that in other examples, the sphere portion 451a may be integrally formed with the slider. In this manner, as long as one sphere portion 451a is formed at an end of the slider, a force may be applied to the pressure sensor along the direction of the first straight line 300a.

In the example shown in FIG. 28A, the triggering surface 451b is a semi-spherical surface. In other examples, a ratio of an area of the triggering surface to an area of the corresponding spherical surface may be any value.

In the example shown in FIG. 28B, a pressure sensor 452 is formed with a triggered surface 452a for being in contact with a triggering surface 453a of a trigger piece 453, where the triggered surface 452a is part of a spherical surface in shape, and the triggering surface 453a may be a plane. In this example, the triggered surface 452a is a hole wall of a hole, where the hole wall is part of a spherical surface.

Alternatively, in the example shown in FIG. 28C, a triggered surface 454a formed on a pressure sensor 454 is a surface of a sphere portion that protrudes upward, the surface of the sphere portion is part of a spherical surface, and a triggering surface 455a of a trigger piece 455 may be a plane.

The preload element 36 is used for biasing the trigger assembly 35 such that the trigger assembly 35 applies a preload force to the pressure sensor 34. In this manner, a nonlinear electrical signal outputted by the pressure sensor 34 at the beginning of deformation can be filtered out, thereby improving the accuracy of the signal processed by the signal processing device.

The handle device 30 further includes a support piece 37, where the support piece 37 is used for supporting the slider 352 and disposed in the first accommodation cavity 331 formed by the housing 33. The support piece 37 is also fixedly connected to the operation member 31. The support piece 37 may also be considered as part of the first whole so that the support piece 37, the operation member 31 and the pressure sensor 34 constitute the preceding first whole. When the user applies the thrust to the grip 311, the support piece 37, the operation member 31 and the pressure sensor 34 together generate a slight motion relative to the second whole along the direction of the first straight line 300a. It is to be noted that a distance of the motion of the first whole relative to the second whole is less than or equal to 3 mm, and the motion of the first whole relative to the second whole is used for providing the trigger piece 351 with a stroke for deforming the pressure sensor 34. That is to say, the distance of the motion of the first whole along the first straight line 300a is the same as a moving stroke of the trigger piece 351 and is also the same as a magnitude of the deformation of the pressure sensor 34. Therefore, the operation member 31, the pressure sensor 34 and the support piece 37 generate a very small motion relative to the connecting rod assembly 32, and the user hardly senses that the operation member 31, the pressure sensor 34 and the support piece 37 move relative to the connecting rod assembly 32. In other words, the user may consider that the operation member 31, the pressure sensor 34 and the support piece 37 do not move relative to the connecting rod assembly 32.

In this example, the operation member 31 and the pressure sensor 34 are both disposed outside the housing 33, and the support piece 37 is disposed in the housing 33. The screws 392 penetrate through the support piece 37, the pressure sensor 34 and the operation member 31 in sequence such that the three are fixedly connected together to form the first whole. The support piece 37 is formed with a support hole 371, and the slider 352 includes a sliding portion 352a disposed in the support hole 371 and a driving portion 352b in contact with the trigger piece 351. The preload element 36 is disposed in the first accommodation cavity 331 formed by the housing 33 and biases the driving portion 352b. In this example, the preload element 36 is a spring. Further, the preload element 36 is a Belleville spring, where the Belleville spring is sleeved on the sliding portion 352a and supports the driving portion 352b. In other examples, the preload element 36 may be a coil spring or a rubber piece. The preload element 36 indirectly biases the trigger piece 351 through the slider 352 so that the trigger piece 351 is always in contact with the pressure sensor 34.

When the operation member 31 receives the thrust, the first whole moves relative to the second whole, and a relative motion for deforming the pressure sensor 34 is generated by the support piece 37 relative to the slider 352 along the direction of the first straight line 300a. A stroke of the relative motion is the same as a stroke of the motion of the first whole relative to the second whole. A maximum value of the relative motion between the support piece 37 and the slider 352 is also less than or equal to 3 mm. In this example, in fact, the slider 352 is fixed relative to the main machine 301, and the support piece 37 moves together with the operation member 31 relative to the main machine 301 so that the relative motion between the support piece 37 and the slider 352 is generated. Since the motion is relative, the motion of the support piece 37 relative to the slider 352 may be considered as a motion of the slider 352 relative to the support piece 37.

In other examples, the slider 352 may be further formed with a sliding hole, and the support piece 37 extends into the sliding hole to support the slider 352.

In this example, the support piece 37 is made of a first material, and the slider 352 is made of a second material, where the second material is different from the first material. The support piece 37 and the slider 352 are made of different materials separately so that the support piece 37 and the slider 352 have different viscosity, thereby reducing a coefficient of friction between the support piece 37 and the slider 352. In this manner, when the relative motion between the support piece 37 and the slider 352 is generated, a relatively small friction is generated between the support piece 37 and the slider 352 so that the pressure sensor 34 can more accurately sense the thrust applied by the user to the grip 311, improving the detection accuracy of the pressure sensor 34 and the reliability of the lawn mower 300.

The coefficient of friction between the support piece 37 and the slider 352 is greater than 0 and less than or equal to 0.3 so that the force transmitted to the pressure sensor 34 is more accurate. Furthermore, the coefficient of friction between the support piece 37 and the slider 352 is greater than 0 and less than or equal to 0.1. To further reduce an effect of the friction between the support piece 37 and the slider 352 on the thrust applied by the user, the coefficient of friction between the support piece 37 and the slider 352 is greater than 0 and less than or equal to 0.05.

Specifically, in this example, the support piece 37 is a metal piece and the slider 352 is a plastic piece. In other examples, the support piece may be a plastic piece and the slider may be a metal piece. Alternatively, in an example, the first material is a first metal and the second material is a second metal, that is to say, the support piece and the slider are made of two different metal materials, separately.

Surface roughness Ra of the support piece 37 is less than or equal to 10 nm, and surface roughness Ra of the slider 352 is less than or equal to 10 nm. Furthermore, the surface roughness Ra of the support piece 37 is less than or equal to 3.2 nm, and the surface roughness Ra of the slider 352 is less than or equal to 3.2 nm. In this manner, when the support piece 37 and the slider 352 move relatively, the friction between the support piece 37 and the slider 352 is relatively small so that a measured value of the thrust detected by the pressure sensor 34 is more accurate. In other examples, the support piece and the slider may be made of the same material, for example, the support piece and the slider are both made of plastic. In this case, to reduce the friction factor between the support piece and the slider, the surface of the support piece or the slider may be plated with a metal layer, for example, the surface of the support piece or the slider is plated with chrome, which can reduce the surface roughness of the support piece and the slider. It is to be noted that, when the surface of the support piece or the slider is plated with a material layer, the surface roughness of the support piece or the slider refers to surface roughness of the material layer.

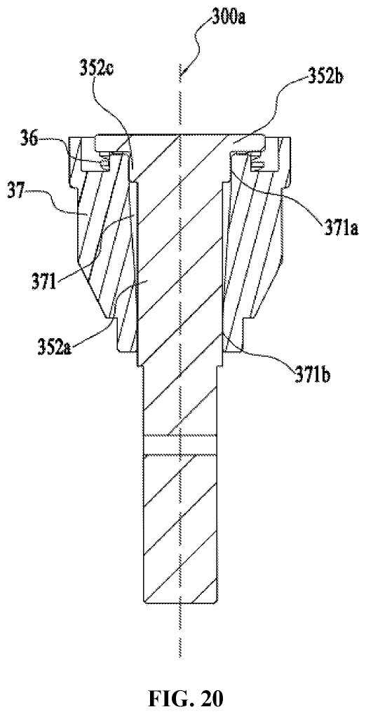

As shown in FIG. 20, the support hole 371 is centered on the first straight line 300a. The sliding portion 352a is partially disposed in the support hole 371. The support hole 371 has a first hole wall portion 371a and a second hole wall portion 371b. Along the direction of the first straight line 300a, the first hole wall portion 371a and the second hole wall portion 371b are disposed at different positions. The first hole wall portion 371a has a first inner diameter, and the second hole wall portion 371b has a second inner diameter, where the first inner diameter is greater than the second inner diameter. That is to say, the first hole wall portion 371a and the second hole wall portion 371b are cylindrical holes with different inner diameters, separately. The slider 352 is formed with a step structure 352c so that the slider 352 can be in contact with both the first hole wall portion 371a and the second hole wall portion 371b. In this manner, a contact area between the slider 352 and the support piece 37 can be reduced so that the effect of the relative motion between the slider 352 and the support piece 37 on the force is further reduced, thereby improving the accuracy with which the pressure sensor 34 detects the thrust applied by the user to the grip 311.

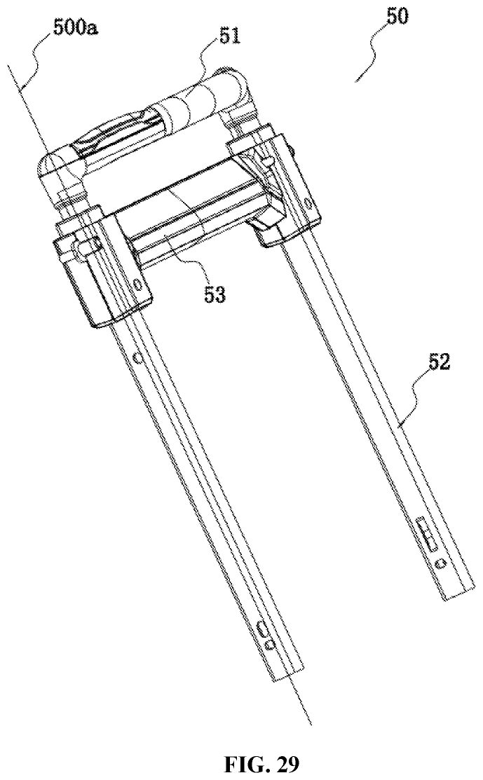

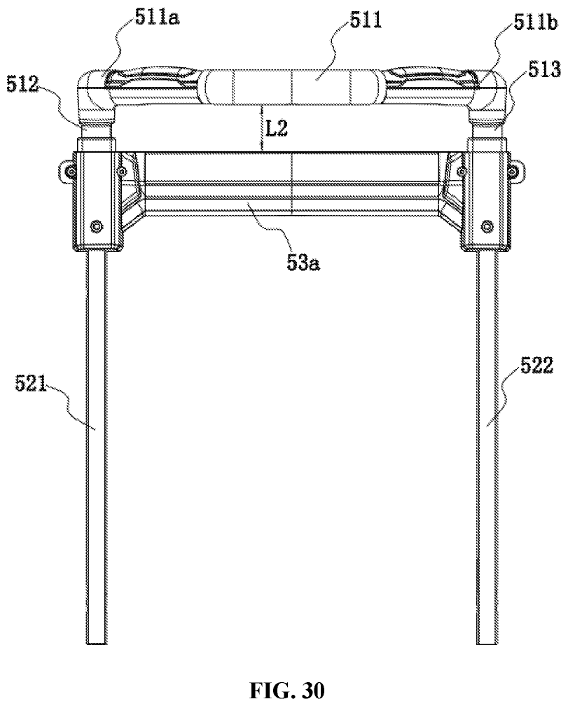

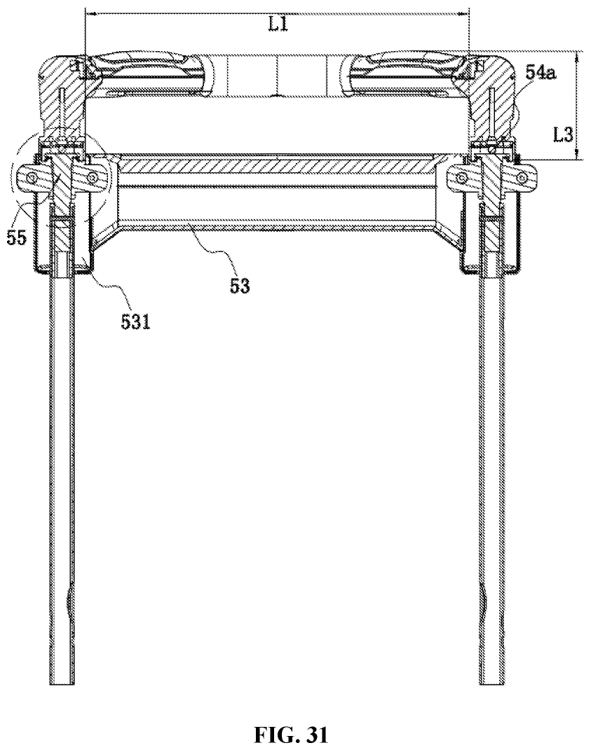

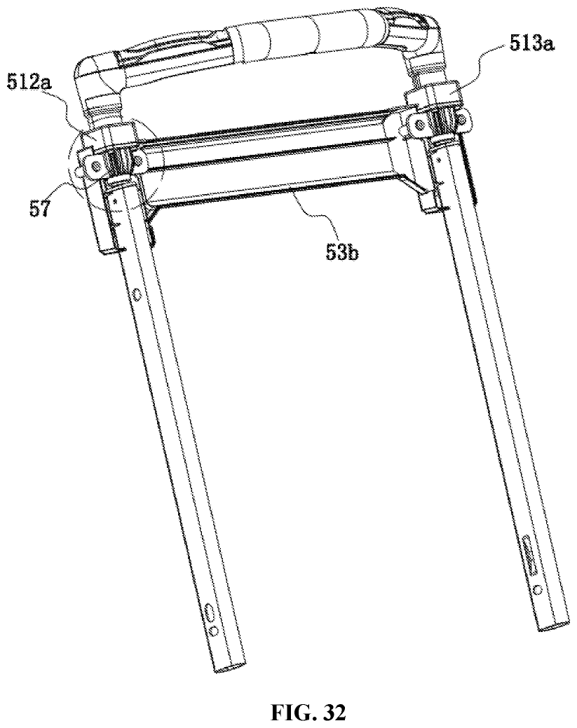

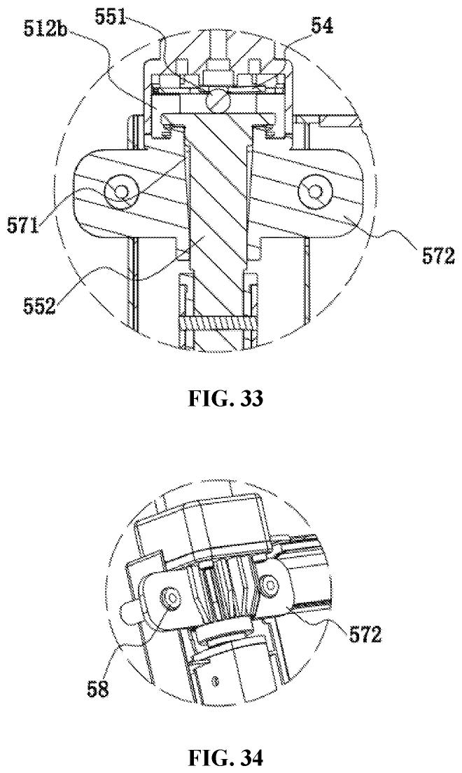

FIG. 29 is a perspective view of a handle device 50 of another lawn mower, and the lawn mower may be another rear-moving, self-propelled working machine with the handle device 50. As shown in FIGS. 29 to 34, the lawn mower may have the same main machine as the lawn mower 300, and the handle device 50 has an operation member 51, a connecting rod assembly 52, a sensing device 54a, a trigger assembly 55, and a preload element that are the same as those of the handle device 30. The main difference is that the housing 33 is fixedly connected to the connecting rod assembly 32 in the lawn mower 300, while a housing 53 is fixedly connected to the operation member 51 in the lawn mower. Any structure of the lawn mower 300 applicable to the lawn mower in this example may be the same as that in this example, and details are not described in detail.

The operation member 51 includes a grip 511 for a user to hold, and two ends of the grip 511 along an extension direction of the grip 511 are defined as a first end 511a and a second end 511b, separately. The operation member 51 further includes a first mounting portion 512 and a second mounting portion 513, where the first mounting portion 512 includes a first mounting end 512a for mounting the sensing device 54a or a trigger piece 551, and the second mounting portion 513 includes a second mounting end 513a for mounting the sensing device 54a or the trigger piece 551. The sensing device 54a includes a pressure sensor 54 for sensing a thrust applied to the handle device 50 to drive the lawn mower, and when the grip 511 receives the thrust, the trigger piece 551 can apply a force to the pressure sensor 54 to drive the pressure sensor 54 to deform. The first mounting portion 512 is disposed at the first end 511a of the grip 511, and the second mounting portion 513 is disposed at the second end 511b of the grip 511. In this example, the first mounting end 512a is formed with a first mounting cavity 512b, the second mounting end 513a is formed with a second mounting cavity, two pressure sensors 54 are provided, and the two pressure sensors 54 are disposed in the first mounting cavity 512b and the second mounting cavity, separately. The trigger piece 551 can apply a force along a direction of a first straight line 500a to the pressure sensor 54.

The handle device 50 further includes a support piece 57 for supporting the operation member 51 and fixedly connected to the operation member 51, and the pressure sensor 54 is fixedly connected to the support piece 57 and the operation member 51. The trigger assembly 55 further includes a slider 552, where the slider 552 is fixedly connected to the connecting rod assembly 52. The support piece 57 is further formed with a support hole 571, and the slider 552 penetrates through the support hole 571 to be in contact with the trigger piece 551. When the user applies a force to the grip 511, a first whole constituted by the operation member 51, the support piece 57 and the pressure sensor 54 is slightly displaced relative to a second whole constituted by the trigger piece 551, the slider 552 and the connecting rod assembly 52, and the trigger piece 551 deforms the pressure sensor 54 through the slight displacement so that the pressure sensor 54 outputs a signal. The slight displacement is the same as a deformation amount of the pressure sensor 54.

In this example, the housing 53 is fixedly connected to the first mounting end 512a and the second mounting end 513a. Therefore, the housing 53 may be referred to as a connecting piece for fixedly connecting the first mounting end 512a and the second mounting end 513a. For ease of description, the technical solutions of the present application are described below with the housing 53 instead of the connecting piece. In fact, the housing 53 is the connecting piece. An extension direction of the first mounting portion 512 is the same as an extension direction of a first connecting rod 521, and an extension direction of the second mounting portion 513 is the same as an extension direction of a second connecting rod 522. The first mounting portion 512 extends along the first straight line 500a, and the second mounting portion 513 extends along a direction parallel to the first straight line 500a. The grip 511 is fixedly connected to upper ends of the first mounting portion 512 and the second mounting portion 513, and the housing 53 is fixedly connected to lower ends of the first mounting portion 512 and the second mounting portion 513. In this manner, the housing 53 can ensure that a distance L1 between the first mounting end 512a and the second mounting end 513a remains basically unchanged. On the one hand, the trigger piece 551 can apply the force to the pressure sensor 54 basically along the direction of the first straight line 500a. On the other hand, the housing 53 can avoid an increase of a friction between the support piece 57 and the slider 552 caused by a change of the distance L1 between the first mounting end 512a and the second mounting end 513a, thereby reducing an effect of the friction between the support piece 57 and the slider 552 on the force. The housing 53 is fixedly connected to the first mounting end 512a and the second mounting end 513a so that the pressure sensor 54 can more accurately detect the thrust applied by the user to the grip 511, thereby improving detection accuracy. The housing 53 is fixedly connected to the first mounting end 512a and the second mounting end 513a, the example is not limited to the direct connection between the housing 53 and the first mounting end 512a or the second mounting end 513a, and the housing 53 may be indirectly fixed to the first mounting end 512a and the second mounting end 513a through other parts. For example, in this example, part of the housing 53 is disposed between the first connecting rod 521 and the second connecting rod 522, two ends of the housing 53 are fixedly connected to two support pieces 57, separately, and the two support pieces 57 are fixedly connected to the first mounting portion 512 and the second mounting portion 513, separately, such that the housing 53 is fixedly connected to the first mounting portion 512 and the second mounting portion 513.

An end of the first mounting portion 512 is connected to the first end 511a of the grip 511, and the other end of the first mounting portion 512 is the first mounting end 512a, where the first mounting end 512a is away from the first end 511a. An end of the second mounting portion 513 is connected to the second end 511b of the grip 511, and the other end of the second mounting portion 513 is the second mounting end 513a, where the second mounting end 513a is away from the second end 511b.

The housing 53 is formed with a first accommodation cavity 531, the connecting rod assembly 52 is inserted into the first accommodation cavity 531, the support piece 57 is at least partially disposed in the first accommodation cavity 531, the housing 53 is fixedly connected to the support piece 57, and the support piece 57 is fixedly connected to the operation member 51 and the pressure sensor 54. The pressure sensor 54 is disposed outside the first accommodation cavity 531 and disposed in the first mounting cavity 512b and the second mounting cavity.

The housing 53 specifically includes a first housing portion 53a and a second housing portion 53b, where the first housing portion 53a and the second housing portion 53b can be separated from each other, and the first housing portion 53a can dock with the second housing portion 53b to form a whole. When the first housing portion 53a docks with the second housing portion 53b, the first housing portion 53a and the second housing portion 53b surround and form the first accommodation cavity 531 into which the connecting rod assembly 52 is inserted. In other examples, the operation member 51 may be inserted into the first accommodation cavity 531. The handle device 50 further includes a mount 58 for fixedly connecting the housing 53 to the support piece 57. In this example, the support piece 57 includes a protrusion 572 that protrudes out of the housing 53, and the mount 58 includes screws, where the screws penetrate through the first housing portion 53a, the protrusion 572 and the second housing portion 53b in sequence, thereby fixedly connecting the housing 53 to the support piece 57.

Along the direction of the first straight line 500a, a distance L2 between the grip 511 and the housing 53 is greater than or equal to 40 mm and less than or equal to 200 mm. A ratio of the distance L2 between the housing 53 and the grip 511 to a dimension L3 of the operation member 51 along the direction of the first straight line 500a is greater than or equal to 0.5 and less than 1. In this manner, the distance between the housing 53 and the grip 511 is large enough so that a distance between the first mounting portion 512 and the second mounting portion 513 can be better ensured.

When the first mounting end 512a and the second mounting end 513a are not fixedly connected by the housing 53, the operation member 51 may cause a change of the distance L1 between the first mounting end 512a and the second mounting end 513a since the user applies the thrust in a different direction; or the deformation of the operation member 51 due to long-term operation causes the distance L1 between the first mounting end 512a and the second mounting end 513a to change; or the operation member 51 is collided by another object, causing the distance L1 between the first mounting end 512a and the second mounting end 513a to change. All these cases cause a measured value of the thrust detected by the pressure sensor 54 to be different from an actual value of the thrust applied by the user to the grip 511. As a result, a speed of a motor controlled by a controller cannot adapt to a moving speed of the user or the thrust applied by the user. For example, before the housing 53 is connected to the first mounting end 512a and the second mounting end 513a, the distance L1 between the first mounting end 512a and the second mounting end 513a may vary within L±3 mm. After the housing 53 is fixedly connected to the first mounting end 512a and the second mounting end 513a, the distance L1 between the first mounting end 512a and the second mounting end 513a varies within L±0.5 mm, thereby greatly reducing the change of the distance between the first mounting end 512a and the second mounting end 513a of the operation member 51 and improving the detection accuracy of the pressure sensor 54.

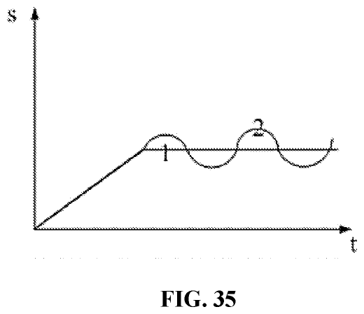

In some relatively advanced lawn mowers, a self-moving system of a lawn mower adaptively adjusts a moving speed of the lawn mower only by sensing a force applied by a user to the lawn mower. In general, in a process of speed adjustment, it is expected to obtain a smooth moving speed under an ideal condition shown by line 1 in FIG. 35. However, the acquisition of the speed is related to the integration of time, for example, the speed

s=a*t (3)

where a denotes a parameter related to a thrust. That is to say, the speed s is related to not only the thrust but also the time. Therefore, when the moving speed of the lawn mower is adjusted based on the thrust of the user, a response in speed has a certain lag. Thus, the speed fluctuates significantly as shown by line 2 in FIG. 35 in a later stage of adjustment, that is, a speed lag increases when the thrust of the user is large, and the speed lag decreases when the thrust of the user is small. Therefore, the user may feel pulled or hindered due to the fluctuation of the moving speed of the lawn mower, and the comfort of the user during mowing operation is still relatively poor. Therefore, another example of the present application provides a lawn mower 200 to solve the preceding problem.

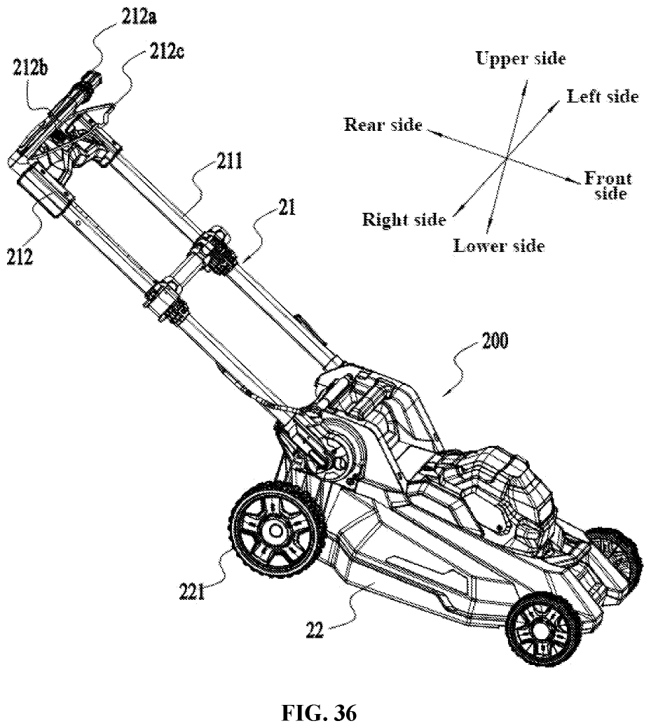

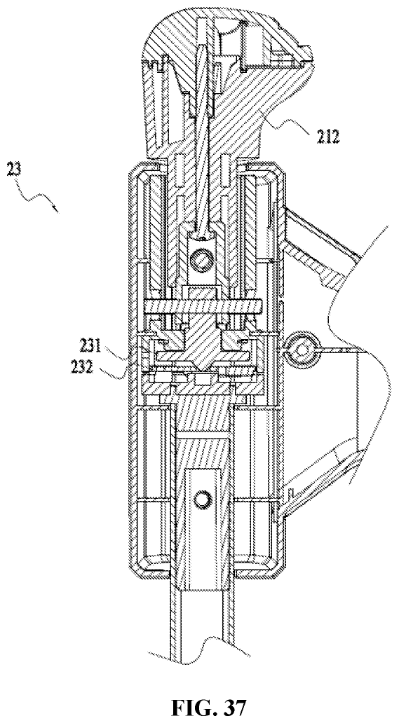

Referring to FIGS. 36 and 37, the lawn mower 200 mainly includes a handle device 21, a connecting rod 211, an operation member 212, an operation switch 212a, a main machine 22, and a moving assembly 221. The main machine 22 includes the moving assembly 221 and a power mechanism (not shown in the figure). Optionally, the handle device 21 includes the connecting rod 211 and the operation member 212 that can be held. The operation member 212 includes a grip for the user to hold and the operation switch 212a; the connecting rod 211 is a hollow long rod structure, and the connecting rod 211 connects the operation member 212 to the main machine 22. The moving assembly 221 is mounted onto the main machine 22 and can rotate around a rotation axis so that the entire lawn mower 200 can move on the ground.

To achieve a convenient operation and an effort-saving effect, the lawn mower 200 in this example has a self-moving control function. The power mechanism can drive the moving assembly 221 to rotate so as to drive the lawn mower 200 to move on the ground, so that the user does not need to manually push the lawn mower 200 to move. Specifically, the power mechanism may be a drive motor 222 which can output a driving force for driving the moving assembly 221 to rotate. In fact, in some examples, the handle device 21 of the lawn mower 200 is further integrated with a power button 212b and a trigger 212c. Exemplarily, the power button 212b, the trigger 212c, and the operation switch 212a of the lawn mower 200 are all integrated on the operation member 212. In addition, the operation switch 212a is not limited to a physical switch or a signal switch, and any device that can control a current in a circuit to be on or off is applicable. In fact, this type of operation switch 212a is not limited to current control and may also control the self-moving function to be enabled or disabled by mechanical means. To increase the convenience of the user's operation, this example provides the lawn mower 200 which is convenient to operate and can adaptively adjust output torque of the drive motor according to the thrust of the user so that the driving force of the motor under the output torque can reach a desired value. It is to be understood that different thrusts correspond to different desired driving forces, and the desired driving forces may be stored in a storage module of a control unit in advance. It is to be understood that the desired driving force outputted by the motor, the thrust of the user, and the resistance of the lawn mower can be balanced. That is, when the thrust of the user is relatively large, the driving force of the lawn mower increases, and when the thrust of the user is relatively small, the driving force of the lawn mower decreases. The driving force of the motor is directly adjusted to adaptively change with the thrust of the user. Since a rotational speed of the motor is not directly adjusted, the lag problem of rotational speed adjustment caused by time integration is avoided, and a real-time, efficient, smooth and non-blocking adaptive control process of the driving force of the motor is achieved so that the user follows in a more comfortable state.

In the example of the present application, a sensing module 23 is disposed between the operation member 212 and the main machine 22. The sensing module 23 may be specifically disposed on the main machine 22 or may be disposed at a position where the operation member 212 and a main body 22 are connected or at any position between the operation member 212 and the main body 22. In this example, the sensing module 23 is disposed between the operation member 212 and the connecting rod 211. The sensing module 23 can output a corresponding first signal by sensing the thrust from the operation member 212. In fact, the sensing module 23 outputs a different first signal in response to a different thrust from the operation member 212. In an example, the sensing module 23 may include a pressing piece 231 and a pressure sensor 232. The pressing piece 231 may be operated to trigger the pressure sensor 232 so that the sensor can process the thrust through strain and convert a magnitude of the thrust into the first signal for calculation or to issue an indication, where the first signal outputted by the pressure sensor may be an analog electrical signal, such as a voltage signal or a current signal or may be an optical signal. In the present application, the first signal is the electrical signal, such as the current signal or the voltage signal.

In the present application, a control unit 24 may acquire the first signal outputted by the pressure sensor and a second signal fed back by the drive motor and control the output torque of the drive motor according to the first signal and the second signal. The output torque of the drive motor is controlled so as to control the driving force of the motor. The second signal fed back by the motor may be a current signal, a voltage signal, the torque of the motor or the like. In the present application, the second signal is the current signal. That is to say, the lawn mower in the present application may adaptively adjust the driving force of the motor according to the thrust of the user so that the thrust applied by the user to the handle device is smaller. Therefore, the user can follow in a more comfortable state under a current thrust and control the lawn mower to work. Following in a comfortable state means that the user does not feel pulled or hindered when pushing the lawn mower to work. It is to be noted that when the user is in the state of following, the driving force of the motor under current output torque, the thrust of the user, and the resistance of the lawn mower in motion can reach a force balanced state within an allowable error range. In the force balanced state, a magnitude of the driving force is positively correlated to the magnitude of the thrust of the user. Exemplarily, it is assumed that the thrust applied by the user to the handle is F1, the control unit 24 adjusts the output torque of the motor according to the thrust, the driving force of the motor is F2 under the torque, and the moving resistance of the lawn mower is F3. When F1+F2-F3=F¬ᵣₑₛᵤₗₜₐₙₜ=ma, the preceding three forces are in the force balanced state, where F¬ᵣₑₛᵤₗₜₐₙₜ denotes a resultant force received by the lawn mower, m denotes the mass of the lawn mower, and a denotes moving acceleration of the lawn mower. It is to be understood that, assuming that the thrust F1 of the user increases, to avoid the user's uncomfortable feeling of strenuous operation due to the application of a relatively large thrust, the lawn mower increases its own driving force according to the thrust so that the increased driving force can overcome the resistance so as to control the lawn mower to continue moving. That is to say, the force balanced state refers to a state in which the thrust is relatively small and the driving force just overcomes the resistance to drive the lawn mower to move.

It is to be noted that, in the related art, the self-moving control system controls the torque of the motor according to the thrust of the user and controls the moving speed of the machine through the torque of the motor. As can be seen from the preceding formulas F¬ᵣₑₛᵤₗₜₐₙₜ=ma and s=a*t, the speed needs to be controlled according to the torque through the integration of time, resulting in a lag of the response in speed. Thus, the user feels pulled or hindered and has relatively low comfort in the self-moving control. The driving force may change in real time in response to a change of the thrust so that a self-moving control process is smoother and the user feels more comfortable.

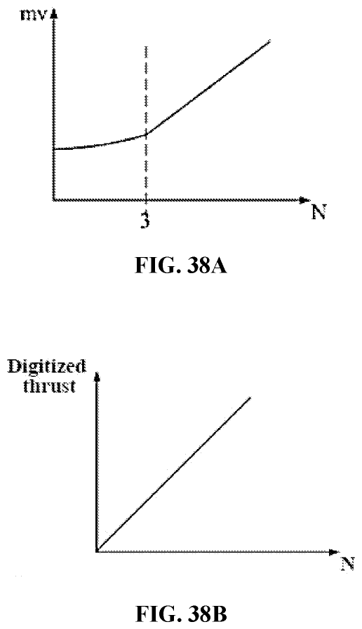

It is to be noted that since the magnitude of the deformation amount of the pressure sensor is relatively small after a force-receiving surface of the pressure sensor is triggered, the electrical signal outputted by the pressure sensor after the deformation is sensed is relatively weak, and the change of the signal is not apparent when the thrust is relatively small. For example, the amplitude of a voltage signal generated by the sensor by sensing the deformation is at an my level. FIG. 38A shows a relationship between the electrical signal and the magnitude of the thrust. When the thrust is relatively small, the change of the electrical signal is not apparent. Therefore, since the signal is relatively weak, the signal is easily lost during a signal transmission process of the pressure sensor, and the change of the signal is not apparent when the thrust is relatively small, affecting the accuracy with which the moving speed of the lawn mower is controlled. Therefore, in the present application, a signal transmission device 233 may be configured to identify the electrical signal outputted by the pressure sensor and transmit the signal to the control unit through bus communication. In an example, the signal transmission device 233 may be disposed at any position adjacent to a periphery of the pressure sensor 232. The signal transmission device 233 acquires the electrical signal outputted by the sensor at a short distance and transmits the signal to the control unit at a long distance through the bus communication, avoiding the case where the electrical signal outputted by the pressure sensor is interfered by an external signal during the transmission to the control unit and the accuracy of the control is affected.

In an optional example, a first signal processing device may be further disposed between the pressure sensor and the signal transmission device, where the device may include a filter and a signal amplifier to perform operational amplification on the electrical signal outputted by the sensor to obtain a first processed signal. It is to be understood that the strength of the first processed signal is greater than the strength of the electrical signal outputted by the sensor, and the electrical signal outputted by the pressure sensor may be enhanced by the first signal processing device, thereby further ensuring that signal transmission of the electrical signal is not interfered by the external signal.

In an optional example, a second signal processing device may be further disposed between the pressure sensor and the signal transmission device, where the device may be integrated with elements such as an analog-to-digital conversion (ADC) chip and a single-chip microcomputer. After the ADC chip performs ADC on the electrical signal outputted by the sensor, the signal is accurately identified by the signal transmission device as a second processed signal, that is, a digital electrical signal. The electrical signal outputted by the pressure sensor can be digitized by the second signal processing device so that the signal transmission device can more easily identify and transmit the digitized electrical signal. For example, from the comparison of FIG. 38B with FIG. 38A, it can be seen that the electrical signal fed back by the pressure sensor is converted into a thrust signal and outputted directly in the form of a digitized thrust value, and the magnitude of the thrust can be accurately reflected even when the thrust is relatively small, ensuring the accuracy with which the moving speed of the lawn mower is controlled.

It is to be understood that both the first processed signal and the second processed signal are obtained through the first level processing on the electrical signal outputted by the pressure sensor, so as to enhance the strength of the signal and avoid the case where the signal is interfered during transmission, affecting the accuracy of the self-moving control.

In addition, due to various factors such as different habits of users or different working conditions, it is possible that the pressure detected on one side cannot accurately reflect the magnitude of the pressure actually received by the lawn mower. To increase the sensitivity and accuracy of the pressure sensor 232 receiving a pressure signal, the pressure sensor may further include a first sensor and a second sensor. The first sensor and the second sensor are disposed at two positions where the operation member 212 and the connecting rod 211 are connected, separately. The first sensor is disposed at a left connection position of the operation member 212 and the connecting rod 211, and the second sensor is disposed at a right connection position of the operation member 212 and the connecting rod 211, where the left connection position and the right connection position may be located at the same position in a horizontal or vertical direction or at different positions in the horizontal or vertical direction. In fact, since the first sensor and the second sensor are installed at different positions and might be affected by the operation of the user, a difference between a first signal and a second signal inputted to a signal processing device 233 is relatively large, and the signal processing device 233 needs to superimpose electrical signals from the first sensor and the second sensor. Specifically, the signal processing device 233 may calculate a thrust value that directly reflects the magnitude of the thrust actually received by the lawn mower according to a sum of the electrical signals outputted by the two sensors.

In addition, in an actual operation process, the first signal and the second signal outputted by the two sensors may also be calibrated, for example, weighted using different coefficients so that a total force inputted by the user can be accurately identified, thereby effectively avoiding erroneous determination when a single sensor is touched. On the other hand, the following case can be effectively avoided: the user who is accustomed to using the right hand or the left hand applies an unbalanced force on the operation member 212 and thus erroneous determination occurs. As another optional example, only one pressure sensor may be provided. A relatively smart sensor is disposed so that a signal is identified according to the operation of the user and a signal is outputted so as to control the self-moving function of the lawn mower 200. Specifically, the preceding sensor may be disposed at any position between the operation member 212 and the connecting rod 211 or disposed on a side of the operation member 212 and the connecting rod 211 or disposed at a position where the connecting rod 211 and the main machine 22 are connected and can generate a signal for output through changes of the force applied to the connecting rod 211 or the main machine 22 and a displacement, so as to control the self-moving function of the lawn mower 200 through the signal. In another example, the pressure sensor 232 may be disposed on the grip of the operation member 212, a gripping force from the hands of the user may directly act on the pressure sensor, and the pressure sensor 232 may feedback the electrical signal according to the sensed thrust applied to the handle device to drive the rear-moving, self-propelled working machine. In this example, the first sensor and the second sensor are specifically two identical pressure sensors. The pressure sensors may specifically be contact pressure sensors or contactless pressure sensors.

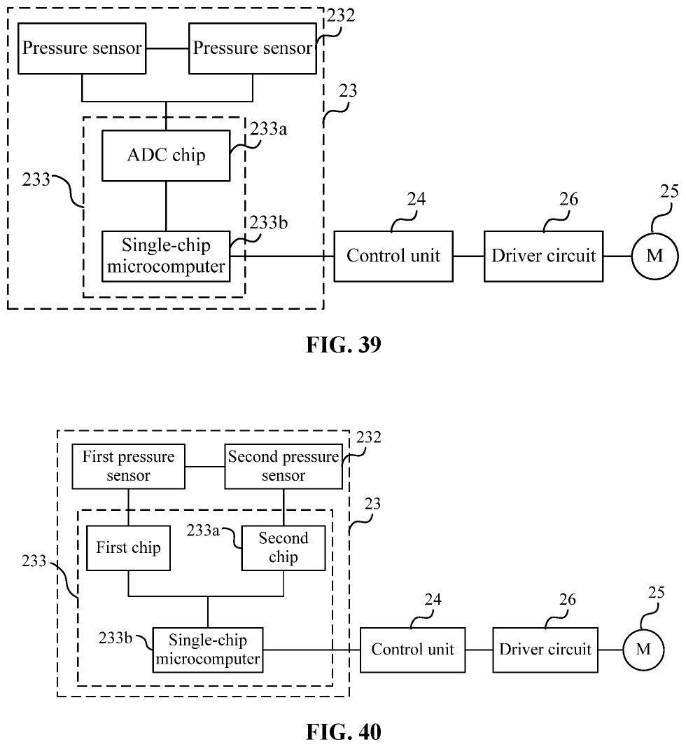

FIG. 39 shows a control principle of the lawn mower. As shown in FIG. 39, the signal processing device 233 may be provided to digitize the electrical signal outputted by the pressure sensor. Specifically, the signal processing device enhances and/or digitizes the electrical signal and finally outputs the electrical signal outputted by the sensor in the form of a thrust value, where the thrust value is the magnitude of the thrust when the user pushes the lawn mower by hand. Further, the signal processing device 233 may transmit the thrust value to the control unit 24 through serial communication or bus communication, and the control unit 24 controls a driver circuit 26 to change an on state to change output torque of a drive motor 25, that is, to change a driving force of the motor, so that the user gains greater operation comfort with a smaller thrust. In an optional example, the signal processing device 233 is included in the sensing module 23, for example, disposed on the pressure sensor or at a position adjacent to the periphery of the pressure sensor. That is to say, when the electrical signal outputted by the pressure sensor is relatively weak, the electrical signal outputted by the pressure sensor is enhanced by the adjacent signal processing device and then transmitted to the control unit 24 instead of being directly outputted, so as to avoid a signal loss during transmission.

In an example, the signal processing device may include a filter and a signal amplifier to filter and amplify the electrical signal outputted by the pressure sensor to obtain an enhanced electrical signal.

In fact, in the present application, the signal processing device 233 may include an ADC chip 233a and a single-chip microcontroller 233b. The ADC chip 233a is directly electrically connected to the pressure sensor 232 to receive the electrical signal fed back by the sensor and perform ADC on the electrical signal. The single-chip microcomputer 233b can acquire the converted electrical signal outputted by the ADC chip, generate a corresponding thrust signal accordingly, and then transmit the thrust signal to the control unit 24 through serial communication or bus communication. Further, the control unit 24 may control an on state of each switching element in the driver circuit 26, so as to change the output torque of the drive motor 25.

In an example, the sensing module 23 may further include a display device (not shown in the figure). When the signal processing device 233 obtains the thrust value after processing, the display device may display the current thrust signal. Optionally, the display device may be independent of the sensing module and disposed at a position where the user is convenient to view the display device, for example, disposed at the handle device.

It is to be understood that the thrust signal in the form of the digitized thrust value is convenient to observe and transmit, but the control unit cannot directly control an electric motor to change output torque according to the digitized thrust signal. In an example, the thrust signal outputted by the single-chip microcontroller 233b may be converted into a control electrical signal by the control unit 24, where the control electrical signal may be a current signal or a voltage signal. The control unit 24 controls the on state of the switching element of the driver circuit according to the control electrical signal, so as to change the output torque of the drive motor so that the driving force of the drive motor can overcome the resistance of the lawn mower, allowing the user to control the lawn mower to move with a smaller thrust. It is to be understood that the output torque of the drive motor 25 is positively correlated to the thrust value, that is, when the thrust of the user is relatively large, the output torque of the drive motor increases and the driving force increases; and when the thrust of the user decreases, the output torque of the drive motor decreases and the driving force decreases.

In an example, when the user turns on the operation switch 212a and pushes the lawn mower 200 to move forward, the user applies a relatively large thrust to the operation member 212. At this time, the pressure sensor 232 transmits a relatively large electrical signal, where the signal is processed by the signal processing device 233, that is, the electrical signals from the two pressure sensors are subjected to the ADC and digitized and merged through the ADC chip and the single-chip microcomputer; and the merged signal is transmitted to the control unit, converted into the control electrical signal by the control unit, and transmitted to the driver circuit 26, and the driver circuit 26 controls, according to the control electrical signal, the drive motor 25 to output relatively large torque. When the thrust applied by the user to the operation member 212 becomes smaller under some working conditions (for example, downhill), the pressure sensor transmits a relatively small electrical signal, where the signal is processed by the signal processing device 233, transmitted to the control unit 24, converted into the control electrical signal by the control unit, and transmitted to the driver circuit, and the driver circuit controls, according to the control electrical signal, the drive motor to output relatively small torque. Optionally, when the user does not touch the operation member 212 or is away from the operation member, the pressure sensor senses no thrust and no longer outputs an electrical signal, and the driver circuit controls, according to a change in value of the electrical signal in the circuit, the drive motor 25 to stop rotating, so as to stop the lawn mower 200.

In an optional example, to prevent the torque of the motor from being frequently changed and the performance of the lawn mower from being affected, the control unit may determine, according to the magnitude of the force applied by the user to the sensor, whether the torque of the motor needs to be changed. That is to say, when the change of the thrust of the user is relatively small, it means that the user operates by hand with no apparent change felt, and the driving force of the motor does not need to be changed. However, when a variation of the thrust is greater than or equal to a variation threshold, that is, when the thrust of the user suddenly increases or decreases, the control unit 24 controls the output torque of the drive motor according to the electrical signal outputted by the pressure sensor so that the driving force of the drive motor under the output torque, the thrust, and the resistance of the rear-moving, self-propelled working machine in motion reach a force balance within an allowable error range.

It is to be understood that in the traditional control manner of adjusting a speed through a switch, when the user toggles a speed regulation switch to a fixed position, the lawn mower moves at a fixed speed. In this case, due to different loads of the lawn mower and different moving speeds of the user, the drive motor may not work in an appropriate current range, resulting in the waste of power. In the present application, magnitudes of a working current may be given according to magnitudes of the thrust of the user under different working conditions, so as to control the torque of the motor and avoid energy waste caused by working at a fixed working current under a fixed moving speed.

In the present application, when the pressure sensor includes the first sensor and the second sensor, the two pressure sensors are connected to the ADC chip together. In fact, since the first sensor and the second sensor are installed at different positions and might be affected by the operation of the user, the difference between the first signal and the second signal inputted to the ADC chip is relatively large, and thus the ADC chip needs to superimpose the electrical signals from the first sensor and the second sensor. In addition, in an actual operation process, the inputted first signal and the inputted second signal need to be calibrated by the ADC chip 233a and/or the single-chip microcomputer 233b, for example, weighted using different coefficients so that the total force inputted by the user can be accurately identified, thereby effectively avoiding erroneous determination when a single sensor is touched. In another example, as shown in FIG. 40, the ADC chip includes a first chip and a second chip. The first chip is connected to the first sensor, the second chip is connected to the second sensor, and the two chips receive the electrical signals from the two pressure sensors and perform ADC separately and output the converted electrical signals to the single-chip microcontroller. The single-chip microcomputer may superimpose and calibrate the electrical signals from the two chips as described above, so as to accurately identify the force of the user.

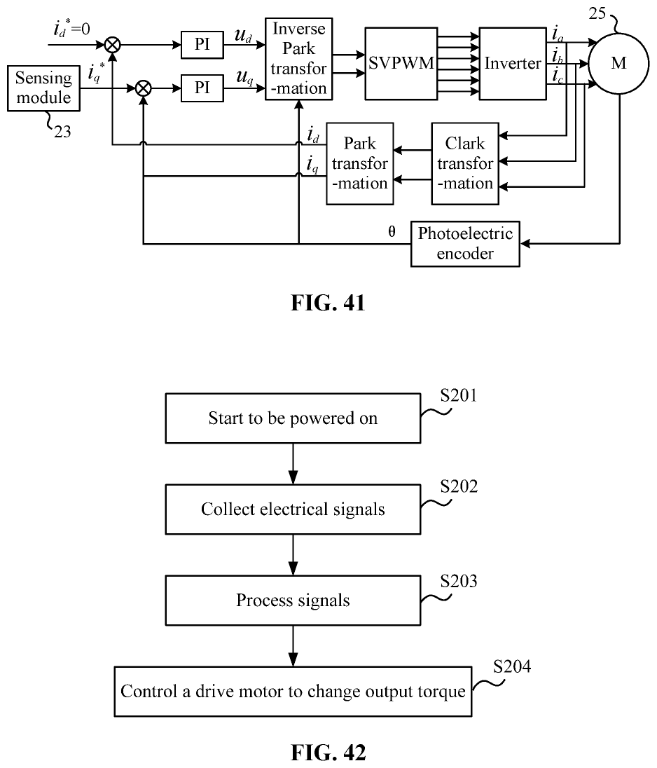

In another example of the present application, the control unit may acquire a phase current fed back by the drive motor and control the output torque of the drive motor according to the phase current and the electrical signal fed back by the pressure sensor so that the driving force of the motor can overcome the resistance, allowing the user to perform comfortable following and control with a smaller thrust. That is to say, the electrical signal fed back by the pressure sensor is a current signal. As shown in FIG. 41, the current signal fed back by the pressure sensor may be decomposed into a quadrature-axis current signal i_{q}* that affects the output torque of the drive motor and a direct-axis current signal i_{d}* that affects a magnetic potential of the motor. In a specific example, i_{d}* is set to zero, and i_{q}* is inputted to a field-oriented control (FOC) current loop control circuit as a set current value to act together with the phase current i_{q} fed back by the drive motor to control the output torque of the drive motor. It is to be noted that in the present application, three-phase currents iₐ, i_{b} and i_{c} fed back by the drive motor in the FOC current control are subjected to Clark transformation and Park transformation, so as to obtain the actual quadrature-axis current i_{q} that can reflect the torque of the motor and the actual direct-axis current i_{d} that can reflect the magnetic potential of the motor. Since the FOC current loop control circuit is a very mature electric motor control manner, details are not described here. In this example, the direct-axis current signal i_{d}* outputted by the signal processing device is set to zero, and only i_{q}* is used as the control electrical signal affecting the output torque of the motor, so as to control the output torque of the motor by the current. It is to be understood that the current signal is positively correlated to the output torque of the drive motor, and the current signal is positively correlated to the thrust signal reflecting the thrust value. That is to say, the greater the thrust of the user, the greater the current, and the greater the output torque of the electric motor; and vice versa.

In the present application, the motion control of the lawn mower is achieved by directly using FOC current loop control, simplifying the control manner, reducing the amount of calculation, and improving the response speed and the mowing efficiency of the machine; at the same time, compared with the manner of controlling the rotational speed of the motor, the manner of directly controlling the output torque of the motor brings a better feeling of actual operation by hand and makes the adjustment process smoother.

As shown in FIG. 42, the present application further provides a method for the rear-moving, self-propelled working machine. The method includes the steps described below.

In S201, the rear-moving, self-propelled working machine starts to be powered on. That is, a lawn mower 100 is connected to a power source, and a power switch is in an on stage.

In S202, first signals fed back by pressure sensors are collected. At this time, two pressure sensors begin to collect the thrust of the user and feed back the corresponding signals.

In S203, the signals are processed.

In the present application, the signal processing specifically includes signal enhancement performed by the signal processing device, such as the ADC performed by the ADC chip and the digitization performed by the single-chip microcomputer, so as to obtain the thrust signal. In addition, the signal processing further includes the conversion of the thrust signal into the control electrical signal by the control unit, so as to control the on state of the driver circuit.

In S204, the drive motor is controlled to change the output torque.

What is claimed is:

1. A rear-moving, self-propelled working machine, comprising:
a main machine comprising a moving assembly and a motor for driving the moving assembly; and
a handle device connected to the main machine;
wherein the handle device comprises:
an operation member comprising a grip for a user to hold;
a connecting rod assembly comprising a first connecting rod connected to the main machine;
a sensing device for sensing a thrust applied to the handle device to drive the rear-moving, self-propelled working machine; and
a trigger assembly capable of applying a force to the sensing device when the grip receives the thrust; and
wherein the trigger assembly is connected to the connecting rod assembly and the sensing device is connected to the operation member.

2. The rear-moving, self-propelled working machine of claim 1, wherein the sensing device comprises a pressure sensor and, when the grip receives the thrust, the trigger assembly applies the force to the pressure sensor to drive the pressure sensor to deform.

3. The rear-moving, self-propelled working machine of claim 2, wherein the handle device further comprises a housing formed with a first accommodation cavity, the first connecting rod extends into the first accommodation cavity, the operation member is formed with a second accommodation cavity, and the pressure sensor is at least partially disposed in the second accommodation cavity.

4. The rear-moving, self-propelled working machine of claim 2, wherein the operation member is disposed outside the housing.

5. The rear-moving, self-propelled working machine of claim 2, wherein the pressure sensor is disposed outside the housing.

6. The rear-moving, self-propelled working machine of claim 2, wherein the trigger assembly comprises:
a trigger piece for applying the force to the pressure sensor; and
a slider connected to the first connecting rod;
wherein the handle device further comprises a support piece for supporting the slider, the slider is in contact with the trigger piece, the support piece is fixedly connected to the operation member, and the slider penetrates through the support piece.

7. The rear-moving, self-propelled working machine of claim 6, wherein, when the operation member receives the thrust, a relative motion between the support piece and the slider is capable of being generated to deform the pressure sensor and wherein a maximum value of the relative motion between the support piece and the slider is less than or equal to 3 mm.

8. The rear-moving, self-propelled working machine of claim 6, wherein the support piece is disposed in the housing.

9. The rear-moving, self-propelled working machine of claim 6, wherein the trigger piece comprises a sphere portion in contact with the pressure sensor.

10. The rear-moving, self-propelled working machine of claim 9, wherein the trigger piece is a sphere.

11. The rear-moving, self-propelled working machine of claim 1, wherein the sensing device comprises a pressure sensor and the handle device further comprises a preload element for biasing the trigger assembly to apply a preload force to the pressure sensor.

12. The rear-moving, self-propelled working machine of claim 1, wherein the connecting rod assembly further comprises a second connecting rod connected to the main machine, the handle device further comprises a housing connecting the first connecting rod and the second connecting rod, the housing is formed with a first accommodation cavity, and the first connecting rod extends into the first accommodation cavity.

13. The rear-moving, self-propelled working machine of claim 12, wherein the pressure sensor is disposed outside the housing.

14. The rear-moving, self-propelled working machine of claim 1, wherein the operation member is formed with an accommodation cavity and the pressure sensor is at least partially disposed in the accommodation cavity.

15. The rear-moving, self-propelled working machine of claim 14, wherein the pressure sensor is fixedly connected to the operation member through screws.

16. A rear-moving, self-propelled working machine, comprising:
a main machine comprising a moving assembly and a motor for driving the moving assembly; and
a handle device connected to the main machine;
wherein the handle device comprises:
an operation member comprising a grip for a user to hold;
a connecting rod assembly comprising a first connecting rod connected to the main machine;
a pressure sensor for sensing a thrust applied to the handle device to drive the rear-moving, self-propelled working machine; and
a trigger assembly capable of applying a force to the pressure sensor when the grip receives the thrust; and
wherein the trigger assembly is connected to the connecting rod assembly, the pressure sensor is connected to the operation member, and the trigger assembly is moveable relative to the pressure sensor so that the trigger assembly is capable of deforming the pressure sensor.

17. The rear-moving, self-propelled working machine of claim 16, wherein the operation member is provided with an accommodation cavity open towards the connecting rod assembly and the pressure sensor is disposed in the accommodation cavity.

18. The rear-moving, self-propelled working machine of claim 17, wherein trigger assembly comprises a trigger piece formed with a triggering surface for being in contact with the pressure sensor and the triggering surface is at least part of a spherical surface.

19. The rear-moving, self-propelled working machine of claim 18, wherein trigger piece is spherical.

20. The rear-moving, self-propelled working machine of claim 18, wherein rear-moving, self-propelled working machine is a lawn mower.
